(19) United States
(12) Patent Application Publication
(10) Pub. No.: US 2026/0308305 A1
(43) Pub. Date: Oct. 8, 2026

(54) STABILIZERS FOR POLYMER FOAMS BASED ON RECYCLING OF POLYDIMETHYLSILOXANE

(71) Applicant: Evonik Operations GmbH, Essen (DE)

(72) Inventors: Thomas Rosen, Duelmen (DE); Michael Ferenz, Essen (DE); Matthias Lobert, Essen (DE); Carsten Schiller, Ratingen (DE)

(73) Assignee: Evonik Operations GmbH, Essen (DE)

(21) Appl. No.: 19/479,888

(22) PCT Filed: Apr. 25, 2024
(86) PCT No.: PCT/EP2024/061368

§ 371 Date: Oct. 29, 2025

(30) Foreign Application Priority Data
May 3, 2023 (EP) 23171226.6

(51) Int. Cl. C08G 18/61; C08G 77/00; C08G 77/46; C08J 11/10

(52) U.S. Cl. CPC C08G 18/61; C08G 77/46; C08J 11/10; C08G 77/70; C08J 2383/04

(57) ABSTRACT

Polyether polydimethylsiloxanes are useful as stabilizers for polymer foams, such as polyurethane foams. Polyether polydimethylsiloxanes can be manufactured based on compounds from the recycling of polydimethylsiloxanes. A process produces polyether polydimethylsiloxanes based on cyclic polydimethylsiloxanes, which are derived from linear or branched polydimethylsiloxanes or copolymers thereof. A process and a composition are used for preparing a polymeric foam making use of the polyether polydimethylsiloxanes, as well as articles produced thereof. A cyclic-polydimethylsiloxane-containing composition and the polyether polydimethylsiloxanes are disclosed for use as foam stabilizers.

### TECHNICAL FIELD

The present invention relates to polyether polydimethylsiloxanes that can be used as stabilizers for polymer foams, such as polyurethane foams. It has been found that polyether polydimethylsiloxanes can be manufactured based on compounds from the recycling of polydimethylsiloxanes. Accordingly, there is provided a process for producing polyether polydimethylsiloxanes based on cyclic polydimethylsiloxanes, which are derived from linear or branched polydimethylsiloxanes or copolymers thereof. The present invention also relates to a process and composition for preparing a polymeric foam making use of the polyether polydimethylsiloxanes as well as articles produced thereof. The present invention is also directed to the use of a cyclic-polydimethylsiloxane-containing composition and to the use of the thus obtained polyether polydimethylsiloxanes as foam stabilizers.

### TECHNICAL BACKGROUND

Foam stabilizers are usually used to ensure the formation of a stable foam. These compounds ensure that the gas produced during the reaction does not escape from the reaction mixture and that the resulting foam remains stable until the reaction is complete to prevent the resulting foam from collapsing. Usually, the polymer foam is a polyurethane foam, a phenol resin foam, or a polyvinylchloride foam.

Frequently utilized foam stabilizers are selected from polyether polydimethylsiloxanes. Suitable starting materials for the manufacturing of polyether polydimethylsiloxanes are thereby generally cyclic polydimethylsiloxanes and preferably octamethylcyclotetrasiloxane. Cyclic polydimethylsiloxanes with high purities are conventionally obtained from chlorosilanes of the Müller-Rochow process (herein abbreviated as MR or MR process) followed by hydrolysis. The Müller-Rochow process is the most common process for preparing organosilicon compounds on an industrial scale directly from natural silicon sources like sand. In the Müller-Rochow process alkyl chlorides react with elemental silicon in a fluidized bed reactor. Unfortunately, the production of cyclic polydimethylsiloxanes via the Müller-Rochow process requires a waste amount of energy. Accordingly, it is desired to reduce the carbon footprint of the production process and the thus produced polyether polydimethylsiloxane foam stabilizers and to provide alternative methods for their preparation.

On the other hand, the accumulation of huge amounts of plastic waste is one of the global challenges that the world is currently facing. Indeed, the serious environmental risks of landfills or the incineration of plastic waste are a growing global concern. Under these conditions, recycling of polymers like polydimethylsiloxane (herein also abbreviated as PDMS) is inevitable for the transition of the polymer industry to carbon neutrality. Polydimethylsiloxane is thereby widely used in industry, for example, in sealants, adhesives, lubricants, cooking utensils, and devices for medical applications, thermal insulation, and electrical insulation.

Different methods for the recycling of polydimethylsiloxane are known. For example, EP 0 009 202 A1 discloses that waste material comprising polyorganylsiloxane can be recycled by means of catalytic depolymerization. To this end, a composition of linear or branched organo-polysiloxanes that consist of at least 50 mol-% dimethylsiloxane units and aqueous sulfuric acid as a catalyst that promotes the rearrangement of siloxane bonds is heated to obtain cyclic dimethylpolysiloxane-containing compositions.

Also, U.S. Pat. No. 5,110,972 A is directed to the recycling of waste silicone by dissolving the silicone in a suitable solvent and converting it into cyclic siloxanes by applying a two-step acid/base catalyzed cracking process. The silicone waste thereby consists of liquids or elastomeric materials of high molecular weight formed by a silicone polymer typically carrying short alkyl groups, especially methyl groups. Cyclic siloxane-containing compositions are finally obtained in high yields by distillation.

CA 2737235 A1 discloses a first step consisting of the production of a hydrogenpolysiloxane comprising reacting decamethylcyclo-pentasiloxane (D5), poly(methyl)hydrogen-siloxane and hexamethyldisiloxane HMDS using a pre-dried ion exchange resin. The obtained polyhydrogen-dimethylsiloxane is then reacted with a polyether of the median formula CH₂═CH—CH₂O—(C₂H₄O—)(C₃H₆O)₂₁CH₃ with a platinum metal complex to form a block polysiloxane-polyoxyalkylene, which is used as a soft polyurethane foam stabilizer.

US 2006/241270 A discloses a first step consisting of the production of a hydrogensiloxane comprising reacting a mixture of decamethylcyclopentasiloxane (D5), poly(methyl)hydrogen-siloxane PTF1 and hexamethyldisiloxane HMDS using pre-dried ion exchange resin. The hydrogensiloxane thus obtained is then further reacted with polyethers of varying average formula to give a polysiloxane (polyoxyalkylene block copolymer).

As detailed above, cyclic polydimethylsiloxanes are a starting material in the production of polyether polydimethylsiloxanes. However, the prior art remains silent regarding the production of polyether polydimethylsiloxanes that are derived from cyclic siloxanes from recycling processes because it is believed in the field that the cyclic siloxanes must have a high purity and that cyclic siloxane compositions from recycling processes would not have the required purity to allow the production of suitable polyether polydimethylsiloxanes foam stabilizers.

Accordingly, there remains an object to provide polyether polydimethylsiloxanes with reduced carbon footprint that are based on products from recycling processes.

### SUMMARY

Surprisingly it has been found that a process for producing polyether polydimethylsiloxanes may solve or alleviate the shortcomings of the prior art, whereby the process comprises: (a) submitting a cyclic-polydimethylsiloxane-containing composition comprising at least one cyclic polydimethylsiloxane to an equilibration reaction with at least one poly(methylhydrogen)siloxane in the presence of at least one equilibration catalyst to form a poly(methylhydrogen)-polydimethylsiloxane copolymer; and (b) submitting the poly(methylhydrogen)-polydimethylsiloxane copolymer obtained in step (a) to a hydrosilylation reaction with at least one polyether comprising at least one carbon-carbon double bond reactive to Si-H bonds, preferably in the presence of at least one hydrosilylation catalyst, to obtain a polyether polydimethylsiloxane; wherein the at least one cyclic polydimethylsiloxane is at least partially derived from at least one linear or branched polydimethylsiloxane or copolymer thereof, wherein the cyclic-polydimethylsiloxane-containing composition comprises at most 300 ppm water as measured according to DIN 51777:2020-04, based on the total weight of the cyclic-polydimethylsiloxane-containing composition, and wherein the at least one linear or branched polydimethylsiloxane or copolymer thereof is contained in a polydimethylsiloxane-containing composition and wherein the polydimethylsiloxane-containing composition
comprises at least 50% by weight, or preferably at least 70% by weight, or more preferably at least 90% percent by weight of the at least one linear or branched polydimethylsiloxane or copolymer thereof, based on the total weight of the polydimethylsiloxane-containing composition; and/or
has a silicon content of from 19% to 38% by weight, preferably from 26% to 38% by weight, more preferably from 34% to 38% weight, based on the total weight of the polydimethylsiloxane-containing composition; and/or
comprises less than 50% by weight, preferably less than 25% by weight, more preferably less than 5% by weight fillers, based on the total weight of the polydimethylsiloxane-containing composition.

The present invention also relates to a composition for preparing a polymer foam comprising at least one monomer and one or more polyether polydimethylsiloxanes obtained according to the process for producing polyether polydimethylsiloxanes disclosed herein, whereby the polymer foam is preferably a polyurethane foam, a phenol resin foam, or a polyvinylchloride foam, more preferably a polyurethane foam.

The present invention is also directed to a method for preparing a polymer foam comprising reacting one or more monomer species in the presence of one or more polyether polydimethylsiloxanes obtained according to the process for producing polyether polydimethylsiloxanes disclosed herein to obtain a polymer foam.

The present invention also provides an article comprising the polymer foam obtained according to the method for preparing a polymer foam disclosed herein or as the reaction product of the composition for preparing a polymer foam disclosed herein.

The present invention further relates to the use of a recycled cyclic polydimethylsiloxane for producing a polyether polydimethylsiloxane, wherein the recycled cyclic polydimethylsiloxane is derived from a linear or branched polydimethylsiloxane or copolymer thereof,

wherein the cyclic-polydimethylsiloxane-containing composition comprises at most 300 ppm water as measured according to DIN 51777:2020-04, based on the total weight of the cyclic-polydimethylsiloxane-containing composition, and
wherein the at least one linear or branched polydimethylsiloxane or copolymer thereof is contained in a polydimethylsiloxane-containing composition and wherein the polydimethylsiloxane-containing composition
comprises at least 50% by weight, or preferably at least 70% by weight, or more preferably at least 90% percent by weight of the at least one linear or branched polydimethylsiloxane or copolymer thereof, based on the total weight of the polydimethylsiloxane-containing composition; and/or
has a silicon content of from 19% to 38% by weight, preferably from 26% to 38% by weight, more preferably from 34% to 38% weight, based on the total weight of the polydimethylsiloxane-containing composition; and/or
comprises less than 50% by weight, preferably less than 25% by weight, more preferably less than 5% by weight fillers, based on the total weight of the polydimethylsiloxane-containing composition.

The present invention furthermore relates to the use of at least one polyether polydimethylsiloxane obtained according to the process for producing polyether polydimethylsiloxanes disclosed herein as an additive in a method of producing a polymer foam or a composition for preparing a polymer foam, whereby the polymer foam is preferably a polyurethane foam, a phenol resin foam, or a polyvinylchloride foam.

Advantageously, the process for producing polyether polydimethylsiloxanes as defined in appended claim 1 provides polyether polydimethylsiloxanes with properties suitable for their application as foam stabilizers. Concomitantly, the polyether polydimethylsiloxanes advantageously have a carbon footprint that is reduced compared to polyether polydimethylsiloxanes obtained from the conventional route based on the Müller-Rochow process.

The above and other objects, features, and advantages of the present invention will become more apparent from the following detailed description.

### DETAILED DESCRIPTION

Any numerical range recited herein is intended to include all subranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value up to 10, and all subranges in between, e.g., 1 to 6.3, or 5.5 to 10, or 2.7 to 6.1. Any endpoints of ranges and/or numbers within those ranges can be combined within the scope of the present disclosure.

A component that is described as being present “up to” or in “at most” a specified amount with no minimum amount stated is not necessarily be present in the respective composition. For example, the cyclic-polydimethylsiloxane-containing composition comprising at most 40 ppm by weight water may be substantially free or even completely free of water.

All parts, amounts, concentrations etc. referred to herein are by weight, unless specified otherwise.

As used herein, the term “comprising” is understood to be open-ended and to not exclude the presence of additional undescribed or unrecited elements, materials, ingredients, or method steps etc. The terms “including”, “containing” and like terms are understood to be synonymous with “comprising”. As used herein, the term “consisting of” is understood to exclude the presence of any unspecified element, ingredient, or method step etc. Although the disclosure has been described in terms of “comprising”, “consisting of” or “consisting essentially of” are also within the scope of the present disclosure. For example, while the disclosure has been described in terms of a cyclic-polydimethylsiloxane-containing composition comprising at least one cyclic polydimethylsiloxane, a cyclic-polydimethylsiloxane-containing composition consisting essentially of and/or consisting of at least one cyclic polydimethylsiloxane is also within the present scope. In this context, “consisting essentially of” means that any additional composition components will not materially affect the relevant properties of the cyclic-polydimethylsiloxane-containing composition in the process for producing polyether polydimethylsiloxanes.

As used herein, the singular form of “a”, “an”, and “the” include plural referents unless the context clearly dictates otherwise.

As used herein, the term “substantially free” means that the material being discussed is present in the composition, if at all, as an incidental impurity. In other words, the material does not affect the properties of the composition. Thus, the material may be present in an amount of less than 1 weight precent, or preferably less than 0.5 weight percent, or more preferably less than 0.1 weight percent. This means that, for example, the cyclic-polydimethylsiloxane-containing composition contains less than 1 weight percent of chlorine-containing compounds or, in some cases, less than 0.05 weight percent of chlorine-containing compounds, wherein such weight percents are based on the total weight of the cyclic-polydimethylsiloxane-containing composition. As used herein, the term “completely free” means that the material is not present in the composition at all. Thus, the cyclic-polydimethylsiloxane-containing composition disclosed herein may contain no chlorine-containing compounds.

Further, the term “polymer” refers to oligomers, homopolymers (e.g., prepared from a single monomer species), copolymers (e.g., prepared form at least two monomer species such as three or more monomer species), and graft polymers.

As already mentioned, the present invention provides a process for producing polyether polydimethylsiloxanes comprising: (a) submitting a cyclic-polydimethylsiloxane-containing composition comprising at least one cyclic polydimethylsiloxane to an equilibration reaction with at least one poly(methylhydrogen)siloxane in the presence of at least one equilibration catalyst to form a poly(methylhydrogen)-polydimethylsiloxane copolymer; and (b) submitting the poly(methylhydrogen)-polydimethylsiloxane copolymer obtained in step (a) to a hydrosilylation reaction with at least one polyether comprising at least one carbon-carbon double bond reactive to Si—H bonds, preferably in the presence of at least one hydrosilylation catalyst, to obtain a polyether polydimethylsiloxane; wherein the at least one cyclic polydimethylsiloxane is at least partially derived from at least one linear or branched polydimethylsiloxane or copolymer thereof,

wherein the cyclic-polydimethylsiloxane-containing composition comprises at most 300 ppm water as measured according to DIN 51777:2020-04, based on the total weight of the cyclic-polydimethylsiloxane-containing composition, and
wherein the at least one linear or branched polydimethylsiloxane or copolymer thereof is contained in a polydimethylsiloxane-containing composition and wherein the polydimethylsiloxane-containing composition
comprises at least 50% by weight, or preferably at least 70% by weight, or more preferably at least 90% percent by weight of the at least one linear or branched polydimethylsiloxane or copolymer thereof, based on the total weight of the polydimethylsiloxane-containing composition; and/or
has a silicon content of from 19% to 38% by weight, preferably from 26% to 38% by weight, more preferably from 34% to 38% weight, based on the total weight of the polydimethylsiloxane-containing composition; and/or
comprises less than 50% by weight, preferably less than 25% by weight, more preferably less than 5% by weight fillers, based on the total weight of the polydimethylsiloxane-containing composition.

As understood herein, a polydimethylsiloxane is a polymer with siloxane units (repeating unit), i.e., O_{1/2}—Si—O_{1/2} units, and methyl substituents (herein abbreviated as “Me”) at the silicon atoms. Thereby, individual siloxane units are interconnected at the oxygen atoms. The O_{1/2}—SiMe₂—O_{1/2} unit is conventionally and herein also denoted as D unit. A polydimethylsiloxane copolymer refers herein to a polymer that comprises beside the O_{1/2}—SiMe₂—O₁₂ repeating unit (D unit) a further repeating unit that is different from O_{1/2}—SiMe₂—O_{1/2}. The polydimethylsiloxanes or copolymers thereof may comprise branching units conventionally and herein denoted as T units and Q units. Thereby, a T unit refers to a Me₁SiO_{3/2} unit and a Q unit refers to a SiO_{4/2} unit. Further, an M unit refers herein to a Me₃SiO_{1/2} unit, thus forming a chain end. A branched polydimethylsiloxane refers to a polydimethylsiloxane comprising T and/or Q units. A branched polydimethylsiloxane copolymer refers to a copolymer that comprises T and/or Q units and/or further branching units in the polymer chain that are not a T unit or Q unit.

The cyclic-polydimethylsiloxane-containing composition utilized in the process for producing polyether polydimethylsiloxanes of the present invention comprises at least one cyclic polydimethylsiloxane. Typically, the cyclic-polydimethylsiloxane-containing composition comprises a mixture of different cyclic polydimethylsiloxanes such as hexamethylcyclotrisiloxane (denoted conventionally and herein as D3), octamethylcyclotetrasiloxane (D4), decamethylcyclopentasiloxane (D5), dodecamethylcyclohexasiloxane (D6), tetradecamethylcycloheptasiloxane (D7), and hexadecamethylcyclooctasiloxane (D8), whereby D4 is typically the most abundant cyclic polydimethylsiloxane in the cyclic-polydimethylsiloxane-containing composition. Advantageously, the cyclic-polydimethylsiloxane-containing composition has an octamethylcyclotetrasiloxane (D4) content of between 40% and 90% by weight, or preferably between 45% and 80% by weight, or more preferably between 50% and 80% by weight, based on the total weight of the cyclic-polydimethylsiloxane-containing composition. Preferably, the cyclic-polydimethylsiloxane-containing composition has a hexamethylcyclotrisiloxane (D3) content of between 0.1% and 6% by weight, or preferably between 0.3% and 5% by weight, or more preferably between 1% and 4% by weight, based on the total weight of the cyclic-polydimethylsiloxane-containing composition. The content of cyclic polydimethylsiloxanes in the cyclic-polydimethylsiloxane-containing composition is preferably determined based on gas chromatography, e.g., according to the method described below. The relative content of cyclic polydimethylsiloxanes in the cyclic-polydimethylsiloxane-containing composition may inter alia depend on the conditions during the process steps for obtaining the cyclic polydimethylsiloxanes, such as the ones detailed hereinbelow, and may be compensated in the equilibration reaction by, e.g., suitably adapting the equilibration reaction time or other process parameters.

The content of cyclic polydimethylsiloxanes (such as D3, D4, D5, D6, D7 and D8) in the cyclic-polydimethylsiloxane-containing composition can be determined as follows. The substances are separated according to the boiling point and detected by means of a thermal conductivity detector (TCD). An aliquot of the sample to be examined is analyzed by GC without further dilution. This is carried out in a gas chromatograph equipped with a split/splitless injector, a capillary column and a thermal conductivity detector under the following conditions: Injector: 290° C., split 40 mL; Injection volume: 1 μL; Column: 5 m*0.32 mm HP5 1 μm; Carrier gas: Hydrogen, const. flow 2 mL/min; Temperature program: 1 minute at 80° C., then 80° C.-300° C. at 30° C./min, then conditioning for 10 minutes at 300° C.; Detector: TCD at 320° C.; Make Up Gas flow: 8 mL/min; Reference gas flow: 22 mL/min. The cyclic siloxanes are separated according to their boiling point. The mass fraction of the individual substances is determined as a percentage of the peak areas determined for the respective substance compared to the total area of all detected substances (area-% method).

The cyclic-polydimethylsiloxane-containing composition can have a total content of the at least one cyclic polydimethylsiloxane of more than 90% by weight, preferably more than 95% by weight, or even more preferably by 98% by weight, based on the total weight of the cyclic-polydimethylsiloxane-containing composition.

The cyclic-polydimethylsiloxane-containing composition may comprise as impurities further siloxanes comprising beside D units also M, T, and Q units. Accordingly, the cyclic-polydimethylsiloxane-containing composition can be characterized by its molar content of M, T, and Q units based on the total mols of M, D, T, and Q units in the cyclic-polydimethylsiloxane-containing composition. In a preferred practice of the present invention, the cyclic-polydimethylsiloxane-containing composition comprises at most 0.25 mol %, or preferably at most 0.15 mol %, or more preferably at most 0.05 mol % of M units, based on the total mols of M, D, T, and Q units in the cyclic-polydimethylsiloxane-containing composition. The sum of T and Q units of the cyclic-polydimethylsiloxane-containing composition can be at most 0.75 mol %, or preferably at most 0.5 mol %, or more preferably at most 0.25 mol %, based on the total mols of M, D, T, and Q units in the cyclic-polydimethylsiloxane-containing composition. The sum of M, T, and Q units of the cyclic-polydimethylsiloxane-containing composition can be at most 1.00 mol %, or preferably at most 0.65 mol %, or more preferably at most 0.3 mol %, based on the total mols of M, D, T, and Q units in the cyclic-polydimethylsiloxane-containing composition. The content of M, D, T, and Q is preferably determined utilizing ²⁹Si NMR spectroscopy. In ²⁹Si NMR spectroscopy M units result in signals in the range of 6 to 9 ppm, D units of

−16 to −24 ppm, T units of −40 to −85 ppm, and Q units of −95 to −140 ppm. The proportion of, the respective unit is determined by setting the sum of the signal intensities of the signals of the respective unit in relation to the sum of the signal intensities of all signals of the M, D, T, and Q units. For example, the content of M units is determined by setting the sum of the signal intensities of the signals from 6-9 ppm in relation to the sum of the signal intensities of all signals of the M, D, T, and Q units. Suitable parameters for recording the ²⁹Si-NMR can be found in the following literature: M. Cypryk, K. Kaimierski, W. Fortuniak, and J. Chojnowski, Macromolecules 2000, 33, 5,1536-1545.

The cyclic-polydimethylsiloxane-containing composition can further be described by the content of components not being cyclic polydimethylsiloxanes such as water, linear siloxanes, and siloxanes comprising hydroxyl or vinyl groups.

In a preferred practice of the present invention, the cyclic-polydimethylsiloxane-containing composition comprises at most 0.05% by weight, or preferably at most 100 ppm by weight, or more preferably at most 40 ppm by weight, or most preferably at most 10 ppm, based on the total weight of the cyclic-polydimethylsiloxane-containing composition, water as measured according to DIN 51777:2020-04. Even more preferably the cyclic-polydimethylsiloxane-containing composition is substantially free or completely free of water. The cyclic-polydimethylsiloxane-containing composition can comprise at most 0.2 mol %, or preferably at most 0.1 mol %, or more preferably at most 0.05 mol %, based on the total mols of silicon atoms in the cyclic-polydimethylsiloxane-containing composition, hydroxyl-substituted silicon atoms as preferably determined based on ²⁹Si-NMR spectroscopy. To this end, the peak area in the ²⁹Si-NMR spectrum is calculated for the signals corresponding to hydroxyl-substituted silicon atoms. Also, the sum of the peak areas for all silicon atom signals without the standard is determined and set into the ratio with the peak area of the hydroxyl-substituted silicon atoms to obtain the molar content of hydroxyl-substituted silicon atoms. A measuring frequency of the NMR measurement of at least 400 MHz is advantageous. Even more preferably the cyclic-polydimethylsiloxane-containing composition is substantially free or completely free of hydroxyl-substituted silicon atoms. Water and hydroxyl-substituted siloxanes may lead to hydrolysis of the SiH functionalities in the equilibration reaction step and therefore finally to polyether polydimethylsiloxane with altered structures and thus potentially deteriorated application properties in polymer foams. Water may also lead to solubilization of the equilibration catalyst thereby potentially slowing down or even completely terminating the equilibration reaction such that no sufficient statistical distribution of the SiH units in the resulting poly(methylhydrogen)-polydimethylsiloxane copolymers may be achieved.

The cyclic-polydimethylsiloxane-containing composition can comprise at most 3% by weight, or preferably at most 2% by weight, or more preferably at most 1% by weight, based on the total weight of the cyclic-polydimethylsiloxane-containing composition, linear siloxanes as preferably measured gas chromatography. To this end, the linear siloxanes can be determined using GC-measurements. A suitable method is the one that is also used for the determination of the cyclic-fractions and is described above. Even more preferably the cyclic-polydimethylsiloxane-containing composition is substantially free or completely free of linear siloxanes. Such linear siloxanes typically have 2 to 6 repeating units. Linear siloxanes introduce M units influencing the chain length of the resulting poly(methylhydrogen)-polydimethylsiloxane copolymer and therefore may necessitate an adaption of the formulation of the equilibration reaction mixture which is unfavorable in terms of process efficiency.

The cyclic-polydimethylsiloxane-containing composition can comprise at most 0.5 mol %, or preferably at most 0.2 mol %, or more preferably at most 0.1 mol %, based on the total mols silicon atoms in the cyclic-polydimethylsiloxane-containing composition, vinyl-substituted silicon atoms as preferably determined based on ²⁹Si-NMR spectroscopy. To this end, the peak area in the ²⁹Si-NMR spectrum is calculated for the signal corresponding to vinyl-substituted silicon atoms. Also, the sum of the peak areas for all silicon atom signals without the standard is determined and set into the ratio with the peak area of the vinyl-substituted silicon atoms to obtain the molar content of vinyl-substituted silicon atoms. A measuring frequency of the NMR measurement of at least 400 MHz is advantageous. Even more preferably the cyclic-polydimethylsiloxane-containing composition is substantially free or completely free of vinyl-substituted silicon atoms. Vinyl-substituted siloxanes provide cross-linking sites of the polymer chains in the subsequent hydrosilylation reaction and therefore potentially lead to an unfavorably increased viscosity of the resulting polyether polydimethylsiloxane.

The at least one cyclic polydimethylsiloxane is at least partially derived from at least one linear or branched polydimethylsiloxane or copolymer thereof. Accordingly, the at least one cyclic polydimethylsiloxane is also denoted herein as at least one recycled cyclic polydimethylsiloxane.

The cyclic-polydimethylsiloxane-containing composition can comprise at least one cyclic polydimethylsiloxane derived from at least one linear or branched polydimethylsiloxane or copolymer thereof in e.g. a recycling process as detailed hereinbelow, i.e. at least one recycled cyclic polydimethylsiloxane, and additionally at least one further cyclic polydimethylsiloxane such as octamethylcyclotetrasiloxane derived, for example, from chlorosilanes of the conventionally applied Müller-Rochow process. Thus, the cyclic-polydimethylsiloxane-containing composition can comprise at least one cyclic polydimethylsiloxane derived from at least one linear or branched polydimethylsiloxane or copolymer thereof in a recycling process as detailed hereinbelow and additionally at least one further cyclic polydimethylsiloxane such as octamethylcyclotetrasiloxane derived from chlorosilanes of the conventionally applied Müller-Rochow process. Preferably, however, the cyclic-polydimethylsiloxane-containing composition is substantially free or completely free of further cyclic polydimethylsiloxanes obtained, for example, based on methylchlorosilanes from the Müller-Rochow process. Accordingly, the at least one cyclic polydimethylsiloxane of the cyclic-polydimethylsiloxane-containing composition is preferably not derived from methylchlorosilanes. Thus, the at least one cyclic polydimethylsiloxane of the cyclic-polydimethylsiloxane-containing composition is preferably not obtained from products of the Müller-Rochow process such as chlorosilanes. Still, the at least one linear or branched polydimethylsiloxane or copolymer thereof submitted to recycling may initially be obtained, for example, from chlorosilanes of the Müller-Rochow process. The cyclic-polydimethylsiloxane-containing composition of the present invention can therefore have a content of chlorine-containing compounds that is below the respective content of cyclic-polydimethylsiloxane-containing compositions derived from methylchlorosilanes. Chlorine-containing compounds as understood herein include inorganic compounds such as chlorine-containing salts like NaCl as well as organic compounds such as chlorosilanes. The cyclic-polydimethylsiloxane-containing composition may comprise less than 100 ppm chlorine-containing compounds, preferably less than 50 ppm chlorine-containing compounds, more preferably less than 25 ppm chlorine-containing compounds, and most preferably less than 10 ppm chlorine-containing compounds, based on the total weight of the cyclic-polydimethylsiloxane-containing composition. Preferably, the cyclic-polydimethylsiloxane-containing composition is substantially free of chlorine-containing compounds or is most preferably completely free of chlorine-containing compounds.

As already mentioned, the at least one cyclic polydimethylsiloxane is at least partially derived from at least one linear or branched polydimethylsiloxane or copolymer thereof. Advantageously, the at least one linear or branched polydimethylsiloxane or copolymer thereof comprises at least 50% by weight, or preferably at least 90% by weight, or more preferably at least 99% by weight dimethylsiloxane units (D units), based on the total weight of the at least one linear or branched polydimethylsiloxane or copolymer thereof. Preferably, the at least one linear or branched polydimethylsiloxane or copolymer thereof comprises a ratio of M units to D units of at least 1:500, or preferably at least 1:750, or more preferably at least 1:1000 as preferably determined by ²⁹Si-NMR spectroscopy. In a preferred practice of the present invention, the at least one linear or branched polydimethylsiloxane is not a copolymer thus comprising only a dimethylsiloxane (D) repeating unit and M units. In a preferred practice of the present invention, the at least one polydimethylsiloxane or copolymer thereof is a linear polydimethylsiloxane. In an even more preferred practice of the present invention, the at least one linear or branched polydimethylsiloxane or copolymer thereof is a linear polydimethylsiloxane homopolymer.

The at least one linear or branched polydimethylsiloxane or copolymer thereof can, for example, correspond to or is derived from a waste polydimethylsiloxane polymer or copolymer material, a wide-spec polydimethylsiloxane polymer or copolymer material, a used polydimethylsiloxane polymer or copolymer material, an expired polydimethylsiloxane polymer or copolymer material, a surplus polydimethylsiloxane polymer or copolymer material, or any mixtures or combinations thereof.

The at least one linear or branched polydimethylsiloxane or copolymer thereof can correspond to different polydimethylsiloxane polymer or copolymer products. For example, the at least one linear or branched polydimethylsiloxane or copolymer thereof can be a polydimethylsiloxane material from a lubricant or a heat transfer oil. The polydimethylsiloxane polymer or copolymer can be a polydimethylsiloxane oil, a polydimethylsiloxane rubber, a polydimethylsiloxanes elastomer, or any mixtures thereof. The polydimethylsiloxane oil refers to the state of aggregation at 25° C. and standard pressure (i.e., 1 atm). For example, the at least one linear or branched polydimethylsiloxane or copolymer thereof can be a mixture of a polydimethylsiloxane oil and a polydimethylsiloxane elastomer or rubber. The linear or branched polydimethylsiloxanes or copolymers thereof can, of course, also be a mixture of two or more different polydimethylsiloxane oils respectively polydimethylsiloxane elastomers or rubbers. Preferred are polydimethylsiloxanes oils. The polydimethylsiloxane oil preferably has a viscosity at 25° C. of at least 1000 mPa·s as preferably measured according to DIN 53019-1:2008-09. If the viscosity is below 1000 mPa·s, the polydimethylsiloxane oil has an unfavorably high fraction of M units which act as chain stoppers in the equilibration reaction. Advantageously, polydimethylsiloxane elastomers or rubbers are shredded before further processing to finally yield at least part of the at least one cyclic polydimethylsiloxane.

Typically, the at least one linear or branched polydimethylsiloxane or copolymer thereof is contained in a polydimethylsiloxane-containing composition that is utilized for producing the at least one cyclic polydimethylsiloxane.

The polydimethylsiloxane-containing composition can be characterized by the weight fraction of the at least linear or branched polydimethylsiloxane or copolymer thereof. Thus, the polydimethylsiloxane-containing composition preferably comprises at least 50% by weight, or preferably at least 70% by weight, or more preferably at least 90% percent by weight, based on the total weight of the polydimethylsiloxane-containing composition, of the at least one linear or branched polydimethylsiloxane or copolymer thereof. The polydimethylsiloxane-containing composition may also essentially consist of or consist of at least one linear or branched polydimethylsiloxane or copolymer thereof.

The polydimethylsiloxane-containing composition can furthermore be characterized by its silicon content. Preferably, the polydimethylsiloxane-containing composition has a silicon content of from 19% to 38% by weight, or preferably from 26% to 38% by weight, or more preferably from 34% to 38% by weight, based on the total weight of the polydimethylsiloxane-containing composition. The silicon content is preferably determined according to the methods described in “Determination of Silicon in Organosilicon Compounds”, J. A. McHard, P. C. Servais, and H. A. Clark, Analytical Chemistry, 1948, 20 (4), 325-328.

Linear or branched polydimethylsiloxane polymer or copolymer products often comprise additives such as fillers, colorants, waxes, cross-linking catalysts, or catalyst residues. Such additives may thus be present in the polydimethylsiloxane-containing composition and can influence the process steps for yielding the cyclic-polydimethylsiloxane-containing composition and subsequent reaction steps if not completely eliminated from the cyclic-polydimethylsiloxane-containing composition. The polydimethylsiloxane-containing composition can be characterized by its content of fillers. Accordingly, the polydimethylsiloxane-containing composition preferably comprises less than 50% by weight, or preferably less than 25% by weight, or more preferably less than 5% by weight, based on the total weight of the polydimethylsiloxane-containing composition, fillers. The polydimethylsiloxane-containing composition can also be substantially free or even completely free of fillers.

The polydimethylsiloxane-containing composition can also be characterized by its content of colorants, which may be contained in linear or branched polydimethylsiloxane polymer or copolymer products. Accordingly, the polydimethylsiloxane-containing composition preferably comprises less than 5% by weight, or preferably less than 3% by weight, or more preferably less than 1% by weight, based on the total weight of the polydimethylsiloxane-containing composition, colorants. The polydimethylsiloxane-containing composition can also be substantially free or even completely free of colorants.

The polydimethylsiloxane-containing composition can also be characterized by its content of polymers that are not polydimethylsiloxanes or copolymers thereof. In a typical practice of the present invention, the polydimethylsiloxane-containing composition is substantially free or even completely free of polyamides. The polydimethylsiloxane-containing composition may comprise at most 5% by weight polypropylene and/or polyethylene based on the total weight of the polydimethylsiloxane-containing composition. In a preferred practice of the present invention, the polydimethylsiloxane-containing composition is substantially free or completely free of polypropylene and/or polyethylene.

The polydimethylsiloxane-containing composition may comprise a total amount of polymers other than polydimethylsiloxanes or copolymers thereof of at most 10% by weight, or preferably at most 5% by weight, or more preferably at most 2% by weight, based on the total weight of the polydimethylsiloxane-containing composition.

The polydimethylsiloxane-containing composition may comprise further components added intentionally or unintentionally to the composition. The polydimethylsiloxane-containing composition may, for example, comprise one or more solvents, which may aid in dissolving the at least one linear or branched polydimethylsiloxane or copolymer thereof. Suitable solvents include, for example, organic solvents, such as cyclopentane, hexane, dimethylbenzene, toluene, xylene, ether, chloroform, and tetrahydrofuran. However, the polydimethylsiloxane-containing composition may also be substantially or completely free of solvents.

The at least one cyclic polydimethylsiloxane is at least partially derived from at least one linear or branched polydimethylsiloxane or copolymer thereof. Advantageously, the at least one cyclic polydimethylsiloxane is at least partially derived from the at least one linear or branched polydimethylsiloxane or copolymer thereof by at least submitting a polydimethylsiloxane-containing composition comprising the at least one linear or branched polydimethylsiloxane or copolymer thereof to catalytic depolymerization in the presence of at least one depolymerization catalyst to form at least one cyclic polydimethylsiloxane in a depolymerization reaction mixture; and distilling the depolymerization reaction mixture to obtain the cyclic-polydimethylsiloxane-containing composition comprising the at least one cyclic polydimethylsiloxane. Distilling may be carried out at least partially during the catalytic depolymerization. The catalytic depolymerization and the distillation as described herein is one process for recycling of a linear or branched polydimethylsiloxane or copolymer. It is particularly preferred that the catalytic depolymerization and the distillation as described herein is used to obtain the at least one cyclic polydimethylsiloxane. Optionally, the cyclic-polydimethylsiloxane-containing composition can be submitted to an additional fractional distillative purification before being submitted to the equilibration reaction of the process of the present invention.

Exemplary reactions for the catalytic depolymerization are revealed in U.S. Pat. No. 5,110,972 A under items D. and E. Furthermore, reaction conditions for the catalytic depolymerization are disclosed in Degradation of silicone-based materials as a driving force for recyclability, Buddhima Rupasinghe and Joseph C Furgal, Polym Int 2022; 71: 521-531, and Full Circle Recycling of Polysiloxanes via Room-Temperature Fluoride-Catalyzed Depolymerization to Repolymerizable Cyclics, Buddhima Rupasinghe and Joseph C Furgal, ACS Appl. Polym. Mater. 2021, 3, 1828-1839. The D3, D4, D5, D6, D7 and D8 content can be adjusted by the type of catalytic depolymerization such as the catalyst, temperature, solvent, water content etc. It is particularly, desired to adjust or control the content of linear siloxanes, water, M-units, T-units, Q-units, Si-hydroxyls and Si-vinyls of the cyclic-polydimethylsiloxane-containing composition before subjecting the cyclic-polydimethylsiloxane-containing composition to the equilibration reaction. Accordingly, the content of linear siloxanes, water, M-units, T-units, Q-units, Si-hydroxyls and Si-vinyls of the cyclic-polydimethylsiloxane-containing composition is chosen as described above. The cyclic-polydimethylsiloxane-containing composition should be purified by distillative purification, such as fractional distillative purification before subjecting the cyclic-polydimethylsiloxane-containing composition to the equilibration reaction.

By utilizing at least one cyclic polydimethylsiloxane from recycling of a linear or branched polydimethylsiloxane or copolymer thereof, the carbon footprint of the at least one cyclic polydimethylsiloxane utilized in the practice of the present invention can be reduced compared to cyclic polydimethylsiloxanes derived, for example, from the Müller-Rochow process, which are conventionally utilized in the preparation of polyether polydimethylsiloxanes. Accordingly, the at least one cyclic polydimethylsiloxane can have a carbon footprint of less than 4 kg CO₂ equivalents/kg of the at least one cyclic polydimethylsiloxane or preferably of less than 2 kg CO₂ equivalents/kg of the at least one cyclic polydimethylsiloxane as determined according to DIN EN ISO standard 14067:2018.

It is preferred that the catalytic depolymerization for obtaining the at least one cyclic polydimethylsiloxane has a carbon footprint of less than 4 kg CO₂ equivalents/kg of the cyclic-polydimethylsiloxane-containing composition or preferably of less than 2 kg CO₂ equivalents/kg of the cyclic-polydimethylsiloxane-containing composition as determined according to DIN EN ISO standard 14067:2018.

The catalytic depolymerization is preferably carried out at a temperature of between 40° C. and 200° C., or preferably between 50° C. and 190° C., or more preferably between 80° C. and 180° C.

The catalytic depolymerization can advantageously be carried out at standard pressure (i.e., 1013 hPa), reduced pressure (<1013 hPa), or else, in order to achieve high heat treatment temperatures up to 200° C., in pressure-rated apparatuses under elevated pressure (>1013 hPa). Preferably, the catalytic depolymerization according to the invention is conducted at a pressure of 1013±10 hPa. Advantageously, the catalytic depolymerization is carried out in a reactor that is resistant to corrosion, temperatures of at least 250° C., and optionally pressures above standard pressure.

The depolymerization reaction is advantageously carried out in the presence of at least one depolymerization catalyst. The at least one depolymerization catalyst is preferably selected from Bronsted acids or Bronsted bases. Preferred Bronsted acids are selected from the group consisting of trifluoromethanesulfonic acid, sulfuric acid, hydrochloric acid, and combinations thereof. Preferred Bronsted bases are selected from the group consisting of alkali metal hydroxides, tetraalkylammonium hydroxides, tetraalkylphosphonium hydroxides, phosphazenes, guanidines, and combinations thereof.

The catalytic depolymerization can also be carried out in a two-step process combining a treatment with an acidic depolymerization catalyst, such as the ones mentioned hereinbefore, followed by treatment with a basic depolymerization catalyst, such as the ones mentioned hereinbefore.

Further components such as solvents can be added to the depolymerization reaction mixture, if needed.

The depolymerization reaction is typically carried out for 1.5 to 6 hours. Thereby, it is preferred that the depolymerization reaction mixture is stirred in order to ensure that the substances are thoroughly mixed.

The catalytic depolymerization step can be carried out batchwise, or as semi-continuous process, or as continuous process.

The cyclic-polydimethylsiloxane-containing composition is submitted in the process of the present invention to an equilibration reaction with at least one poly(methylhydrogen)siloxane and in the presence of at least one equilibration catalyst to form a poly(methylhydrogen)-polydimethylsiloxane copolymer in an equilibration reaction mixture. As utilized herein, an equilibration reaction refers to the reorganization of cyclic polydimethylsiloxanes with an poly(methylhydrogen)siloxane in the presence of at least one equilibration catalyst resulting in the formation of a poly(methylhydrogen)-polydimethylsiloxane copolymer in an equilibration reaction mixture. The poly(methylhydrogen)-polydimethylsiloxane copolymer typically has the general molecular structure according to Formula 1, whereby the units m and n are preferably statistically distributed in the structure:

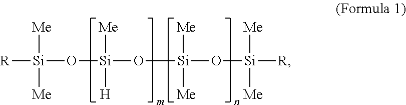

wherein R is independently selected from methyl and hydrogen. Preferably R is methyl.

Typically, one or more chain length modifiers are also added to the equilibration reaction mixture for controlling the chain length of the resulting poly(methylhydrogen)-polydimethylsiloxane copolymer. Thereby, the amount of the one or more chain length modifiers added to the equilibration reaction mixture may be adjusted based on the amount of M units contained in the cyclic-polydimethylsiloxane-containing composition. One typical chain length modifier is hexamethyldisiloxane, which introduces only M units. Alternatively, or additionally, 1,1,3,3-tetramethyldisiloxane may be added to the equilibration reaction mixture, which introduces hydrogen containing end units (HSiMe₂—, so-called M′ units). Also, HSiMe₂-endfunctional polydimethylsiloxane oils, which have the general formula HSiMe₂—O—(—SiMe₂—O—)_{q}—SiMe₂H, may be added, which introduce D units and M′ units. Such oils may have of the CAS number 70900-21-9. Preferably the HSiMe₂-endfunctional polydimethylsiloxane oil has about 5 to 10 dimethylsiloxane units (D units); i.e. q=5 to 10.

The poly(methylhydrogen)siloxane may have the molecular structure according to Formula 2:

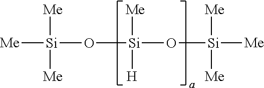

The poly(methylhydrogen)siloxane may have a SiH content of from 4.5 to 16.7 mol/kg or preferably from 10 to 16.5 mol/kg, based on the weight of the poly(methylhydrogen)siloxane. One particularly suitable poly(methylhydrogen)siloxane has a SiH content of about 16 mol/kg and a molar mass Mn of about 2500 g/mol.

As already mentioned, the equilibration reaction is carried out in the presence of at least one equilibration catalyst. Typically, the at least one equilibration catalyst is selected from acidic equilibration catalysts. Suitable acidic equilibration catalysts are strong protic acids such as sulfuric acid, trifluoromethanesulfonic acid, methane sulfonic acid, and perchloric acid, protic and Lewis acids such as HCl+FeCl₃ and HCl+SbCl₆, acid-activated minerals such as bleaching earths like bentonites, montmorillonites, and Fuller's earth, and cation exchange resins such as sulfonic acid, macro-crosslinked cation exchange resins, as well as mixtures thereof.

The amount of the at least one equilibration catalyst is preferably from 0.02 to 10% by weight, or more preferably from 0.05 to 8% by weight, based on the total weight of the equilibration reaction mixture. The amount of the at least one equilibration catalyst in the equilibration reaction mixture may be adjusted based on the amount of water and hydroxyl-substituted silicon atoms in the cyclic-polydimethylsiloxane-containing composition.

The equilibration reaction can be carried out at a temperature of between 10° C. and 110° C., or preferably between 25° C. and 100° C. The equilibration reaction can be carried out at reduced pressure (<1013 hPa), standard pressure (1013 hPa), or superatmospheric pressure (>1013 hPa). Preferably, the equilibration reaction is carried out at a pressure of 950 hPa to 1100 hPa, or more preferably at 1013 hPa.

The equilibration reaction can be carried out in 20 minutes to 20 hours, or preferably of 30 minutes to 14 hours. However, it is desired that the equilibration reaction is carried out in 20 minutes to 7 hours, or preferably of 30 minutes to 5 hours. Thereby, the equilibration reaction time should be chosen such that the molecular weight distribution, the distribution of SiH functionalities, and the molecular structure of the poly(methylhydrogen)-polydimethylsiloxane copolymer have reached the equilibrium state. If the equilibrium state has not been reached, the subsequent hydrosilylation reaction making use of the poly(methylhydrogen)-polydimethylsiloxane copolymer may lead to a greatly turbid polyether polydimethylsiloxane solution, which, when used as foam stabilizer in, for example, polyurethane soft foam systems, often lead to great foam decay up to foam collapse.

If desired, the equilibration reaction can be carried out in the presence of one or more solvents. Suitable solvents are all those solvents which, in the equilibration reaction, are inert to the equilibration catalysts, starting materials and products. Particularly preferably, however, the equilibration reaction is carried out in the absence of a solvent.

The equilibration step can be carried out batchwise, semi-continuously, or continuously.

It can be advantageous to separate off a subquantity having a desired boiling range from the equilibration reaction mixture. The remaining residue of the equilibration reaction mixture which does not have the desired boiling range can be fed again into the equilibration reaction, to be used again, for example, as starting material. Particularly preferably, in particular when the process is carried out continuously, a subquantity having a desired boiling range is separated off from the equilibration reaction mixture and the remainder which does not have the desired boiling range is fed again into the equilibration reaction mixture. This separation can proceed, for example, by a simple thermal separation (such as, for example, by simple distillation or by similar measures). The fraction having the unwanted boiling range can, for example, be recirculated into the feed of the cyclic polydimethylsiloxane composition, when the equilibration reaction step is carried out as a continuous process.

If necessary, and especially if the equilibration step is carried out as a batch process, cyclic polydimethylsiloxanes as toxicologically critical components and other volatiles are removed from the equilibration reaction mixture by applying heat and vacuum after the equilibration state has been achieved. The remainder of the equilibration reaction mixture can further be filtered to remove, for example, solid-phase equilibration catalysts, if present. The thus obtained poly(methylhydrogen)-polydimethylsiloxane copolymer can be submitted to the hydrosilylation reaction step without any further purification.

The poly(methylhydrogen)-polydimethylsiloxane copolymer obtained in the equilibration reaction step can be characterized by its density, viscosity, and SiH value. The poly(methylhydrogen)-polydimethylsiloxane copolymer can have a density at 25° C. of from 0.95 to 0.98 g/mL, or preferably from 0.96 to 0.98 g/mL, or more preferably from 0.97 to 0.98 g/mL as preferably determined according to DIN 51757:2011-01. The poly(methylhydrogen)-polydimethylsiloxane copolymer can have a viscosity at 25° C. of from 2 to 2000 mPa·s, or preferably from 3 to 1000 mPa·s, or more preferably from 10 to 500 mPa·s as preferably determined according to DIN 53019-1:2008-09. The poly(methylhydrogen)-polydimethylsiloxane copolymer can have an SiH value corresponding to the content of SiH functionalities of from 0.2 to 10 mol/kg, or preferably from 0.4 to 8 mol/kg, or more preferably from 0.6 to 6 mol/kg as preferably measured with gas volumetry. To this end, a weighed sample of the poly(methylhydrogen)-polydimethylsiloxane copolymer is decomposed by means of a sodium butylate solution to form hydrogen gas. The amount of hydrogen gas is measured and the SiH value is determined using the definition of the SiH value: n(H₂) [mol]/m(sample) [kg].

The poly(methylhydrogen)-polydimethylsiloxane copolymer can have (A) a density at 25° C. of from 0.94 to 0.99 g/mL, preferably from 0.95 to 0.98 g/mL, or more preferably from 0.96 to 0.98 g/mL determined according to DIN 51757:2011-01; a viscosity at 25° C. of from 50 to 70 mPa·s, preferably from 52 to 64 mPa·s, more preferably from 53 to 63 mPa·s determined according to DIN 53019-1:2008-09; and an SiH value of from 1.1 to 1.60 mol/kg, preferably from 1.0 to 1.50 mol/kg, more preferably from 1.2 to 1.45 mol/kg measured with gas volumetry; or (B) a density at 25° C. of from 0.95 to 1.00 g/mL, preferably from 0.96 to 0.99 g/mL, or more preferably from 0.965 to 0.972 g/mL determined according to DIN 51757:2011-01; a viscosity at 25° C. of from 60 to 85 mPa·s, preferably from 64 to 84 mPa·s, more preferably from 67 to 85 mPa·s determined according to DIN 53019-1:2008-09; and an SiH value of from 1.40 to 1.80 mol/kg, preferably from 1.50 to 1.70 mol/kg, more preferably from 1.57 to 1.67 mol/kg measured with gas volumetry.

According to the process of the present invention, the poly(methylhydrogen)-polydimethylsiloxane copolymer is submitted to a hydrosilylation reaction with at least one polyether comprising at least one carbon-carbon double bond reactive to Si—H bonds, preferably in the presence of at least one hydrosilylation catalyst, to obtain a polyether polydimethylsiloxane.

The hydrosilylation reaction is described, for example, in EP 1 520 870 A1. In this reaction, the SiH functional groups react with the carbon-carbon double bond of the polyether to form Si—C bonds and thus link the polyether to the polydimethylsiloxane copolymer. The obtained polyether polydimethylsiloxane thus comprises dimethylsiloxane units as well as siloxane units in which the silicon atom is substituted with a methyl group and with a polyether derived from the at least one polyether comprising at least one carbon-carbon double bond reactive to Si—H bonds. In case the at least one polyether comprising at least one carbon-carbon double bond reactive to Si—H bonds comprises more than one carbon double bond reactive to Si—H bonds, the polyether moiety may be linked to two or more siloxane moieties. Preferably, however, the at least one polyether comprising at least one carbon-carbon double bond reactive to Si—H bonds comprises only one carbon-carbon double bond reactive to Si—H bonds.

As the at least one polyether comprising at least one carbon-carbon double bond reactive to Si—H bonds all the respective compounds known in the art can be utilized. Examples of suitable polyether comprising at least one carbon-carbon double bond reactive to Si—H bonds include:

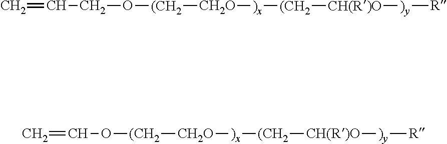

in which
x=0 to 100;
y=0 to 100;
R′ are same or different groups from the selection: substituted alkyl group having 1 to 4 carbon atoms or phenyl;
R″ is a hydrogen radical or an alkyl group having 1 to 4 carbon atoms; the group —C(O)—R′″ in which R′″=alkyl radical; the group —CH₂—O—R′; an alkylaryl group, such as the benzyl group; the group —C(O)NH—R′.

The at least one polyether comprising at least one carbon-carbon double bond reactive to Si—H bonds is preferably selected from the group consisting of polyethers with the CAS numbers 27274-31-3, 9042-19-7, 9041-33-2, 27252-80-8, 62744-60-9, 52232-27-6, 27252-87-5, 132935-51-4, and 56090-69-8.

In addition to the at least one polyether comprising at least one carbon-carbon double bond reactive to Si—H bonds, at least one compound which is not a polyether and which comprises at least one carbon-carbon double bond reactive to Si—H bonds may also be present in the hydrosilylation reaction mixture and may take part in the hydrosilylation reaction. Such compounds are, however, preferably present only in small amounts, if present at all, such as in at most 15 mol %, or preferably at most 10 mol %, based on the total mols of the at least one polyether comprising at least one carbon-carbon double bond reactive to Si—H bonds and the at least one compound which is not a polyether and which comprises at least one carbon-carbon double bond reactive to Si—H bonds.

Suitable hydrosilylation catalysts comprise noble metals such as Pt(0) or rhodium. A suitable Pt(0) catalyst is, for example, disclosed in EP 1 520 870 A1.

The hydrosilylation reaction may be carried out in the presence of one or more solvents, if necessary, which can be separated from the obtained polyether polydimethylsiloxane by means of, e.g., distillation.

The hydrosilylation reaction can be carried out at a temperature of between 20° C. and 140° C., or preferably between 40° C. and 130° C., and more preferably between 60° C. and 110° C.

According to the invention, the process is preferably carried out at standard pressure (1013 hPa), but pressure ranges deviating from this are also possible, if desired.

The polyether polydimethylsiloxane can be characterized by its viscosity. Thus, the polyether polydimethylsiloxane can have a viscosity at 25° C. of from 100 mPa·s to 12000 mPa·s or preferably from 200 to 8000 mPa·s as preferably determined according to DIN 53019-1:2008-09, DIN 53019-2:2008-09, DIN 53019-3:2008-09 and DIN 53019-4:2008-09.

The polyether polydimethylsiloxane can have (A) a density at 25° C. of from 1.030 to 1.060 g/mL, preferably from 1.032 to 1.057 g/mL, or more preferably from 1.035 to 1.055 g/mL determined according to DIN 51757:2011-01; and a viscosity at 25° C. of from 700 to 1300 mPa·s, preferably from 750 to 1250 mPa·s, more preferably from 800 to 1200 mPa·s determined according to DIN 53019-1:2008-09; or (B) a density at 25° C. of from 1.010 to 1.050 g/mL, preferably from 1.015 to 1.045 g/mL, or more preferably from 1.020 to 1.040 g/mL determined according to DIN 51757:2011-01; and a viscosity at 25° C. of from 500 to 1000 mPa·s, preferably from 530 to 900 mPa·s, more preferably from 550 to 850 mPa·s determined according to DIN 53019-1:2008-09.

The present invention also provides a composition for preparing a polymer foam comprising at least one monomer species and one or more polyether polydimethylsiloxanes obtained according to the process disclosed hereinbefore. The composition for preparing a polymer foam may comprise in addition to the polyether polydimethylsiloxane obtained according to the process disclosed herein at least one further polyether polydimethylsiloxane that is not obtained by the herein disclosed process and that may be based on, e.g., cyclic polydimethylsiloxanes from the Müller-Rochow process. In a preferred practice of the present invention the polymer foam is a polyurethane foam, a phenol resin foam, or a polyvinylchloride foam. A polyurethane foam is particularly preferred. The polyurethane foam can in particular be a flexible polyurethane foam, a rigid polyurethane foam, a semi rigid polyurethane foam, a moulded polyurethane foam, a high resilience polyurethane foam, a viscoelastic foam, a hypersoft polyurethane foam, or an integral foam.

A composition for preparing a polyurethane foam typically comprises at least one isocyanate-reactive compound having in average at least two groups per molecule being reactive to isocyanate groups; at least one polyisocyanate having in average at least two isocyanate groups per molecule; at least one blowing agent; at least one catalyst; at least one polyether polydimethylsiloxane as obtained according to the process disclosed herein and optionally one or more additives selected from the group comprising dyes, pigments, fillers, antistatic additives, crosslinkers, chain extenders, cell openers, nucleating agents, thickeners, fragrances, cell expanders, plasticizers, hardening promoters, additives for preventing cold flow, aldehyde scavengers, additives for increasing resistance of polyurethane foams towards hydrolysis, compatibilizers (emulsifiers), adhesion promoters, and hydrophobization additives.

The present invention also relates to a method for preparing a polymer foam, such as the ones mentioned hereinbefore, comprising reacting one or more monomer species in the presence of one or more polyether polydimethylsiloxanes obtained according to the process disclosed herein to obtain a polymer foam. Additionally, at least one further polyether polydimethylsiloxane that is not obtained by the herein disclosed process and that may be based on, e.g., cyclic polydimethylsiloxanes from the Müller-Rochow process may also be present.

A method for preparing a polyurethane foam may comprise providing a composition comprising at least one isocyanate-reactive compound having in average at least two groups being reactive to isocyanate groups, one or more polyether polydimethylsiloxanes obtained according to the process disclosed herein, at least one blowing agent, at least one catalyst, and optionally one or more further additives; contacting the composition with a polyisocyanate having in average at least two isocyanate groups per molecule or a mixture of polyisocyanates; and curing the composition under the formation of a polyurethane foam.

The present invention also relates to an article comprising the polymer foam obtained according to the method for preparing a polymer foam disclosed hereinbefore or as the reaction product of the composition for preparing a polymer foam disclosed hereinbefore. Articles comprising a polyurethane foam as the polymer foam of the present invention may be a refrigerator insulation, an insulation panel, a sandwich element, a pipe insulation, a spray foam, a 1- or 1.5-component can foam, an imitation wood, a modelling foam, a packaging foam, a mattress, a furniture cushioning, an automotive seat cushioning, a seat cushioning in a plane or a train, a headrest, an armrest, an instrument panel, an automotive interior trim, an automotive headlining, a sound absorption material, a steering wheel, a shoe sole, a carpet backing foam, a filter foam, a sealing foam, a sealant, an adhesive, a coating, or for use in manufacturing corresponding products.

The present invention furthermore relates to the use of a recycled cyclic polydimethylsiloxane for producing a polyether polydimethylsiloxane, wherein the recycled cyclic polydimethylsiloxane is derived from a linear or branched polydimethylsiloxane or copolymer thereof, wherein the cyclic-polydimethylsiloxane-containing composition comprises at most 300 ppm water 5 as measured according to DIN 51777:2020-04, based on the total weight of the cyclic-polydimethylsiloxane-containing composition, and wherein the at least one linear or branched polydimethylsiloxane or copolymer thereof is contained in a polydimethylsiloxane-containing composition and wherein the polydimethylsiloxane-containing composition
comprises at least 50% by weight, or preferably at least 70% by weight, or more preferably at least 90% percent by weight of the at least one linear or branched polydimethylsiloxane or copolymer thereof, based on the total weight of the polydimethylsiloxane-containing composition; and/or
has a silicon content of from 19% to 38% by weight, preferably from 26% to 38% by weight, more preferably from 34% to 38% weight, based on the total weight of the polydimethylsiloxane-containing composition; and/or
comprises less than 50% by weight, preferably less than 25% by weight, more preferably less than 5% by weight fillers, based on the total weight of the polydimethylsiloxane-containing composition.

The recycled cyclic polydimethylsiloxane can in particular have a carbon footprint of less than 4 kg CO₂ equivalents/kg of the recycled cyclic polydimethylsiloxane or preferably of less than 2 kg CO₂ equivalents/kg of the recycled cyclic polydimethylsiloxane as determined according to DIN EN ISO standard 14067:2018.

The present invention is also directed to the use of a cyclic-polydimethylsiloxane-containing composition comprising at least one cyclic polydimethylsiloxane in an equilibration reaction for obtaining a poly(methylhydrogen)-polydimethylsiloxane copolymer in a process for producing a polyether polydimethylsiloxane, wherein the at least one cyclic polydimethylsiloxane is at least partially derived from at least one linear or branched polydimethylsiloxane or copolymer thereof. The use may further comprise submitting the poly(methylhydrogen)-polydimethylsiloxane copolymer obtained in the equilibration reaction to a hydrosilylation reaction with at least one polyether comprising at least one carbon-carbon double bond reactive to Si—H bonds, preferably in the presence of at least one hydrosilylation catalyst, to obtain the polyether polydimethylsiloxane. The components and reaction conditions are thereby preferably selected as described hereinbefore.

Further, the present invention also relates to the use of at least one polyether polydimethylsiloxane obtained according to the process disclosed herein as an additive in a method of producing a polymer foam or a composition for preparing a polymer foam, whereby the polymer foam is preferably a polyurethane foam, a phenol resin foam, or a polyvinylchloride foam. A polyurethane foam is particularly preferred.

The invention is further described according to the following aspects.
1. A process for producing polyether polydimethylsiloxanes comprising:
(a) submitting a cyclic-polydimethylsiloxane-containing composition comprising at least one cyclic polydimethylsiloxane to an equilibration reaction with at least one poly(methylhydrogen)siloxane in the presence of at least one equilibration catalyst to form a poly(methylhydrogen)-polydimethylsiloxane copolymer; and
(b) submitting the poly(methylhydrogen)-polydimethylsiloxane copolymer obtained in step (a) to a hydrosilylation reaction with at least one polyether comprising at least one carbon-carbon double bond reactive to Si—H bonds, preferably in the presence of at least one hydrosilylation catalyst, to obtain a polyether polydimethylsiloxane;
wherein the at least one cyclic polydimethylsiloxane is at least partially derived from at least one linear or branched polydimethylsiloxane or copolymer thereof.
2. A process for producing polyether polydimethylsiloxanes comprising:
(c) submitting a polydimethylsiloxane-containing composition comprising at least one linear or branched polydimethylsiloxane or copolymer thereof to catalytic depolymerization in the presence of at least one depolymerization catalyst to form at least one cyclic polydimethylsiloxane in a depolymerization reaction mixture; and
(d) distilling the depolymerization reaction mixture to obtain the cyclic-polydimethylsiloxane-containing composition comprising the at least one cyclic polydimethylsiloxane;
(e) optionally submitting the cyclic-polydimethylsiloxane-containing composition comprising the at least one cyclic polydimethylsiloxane obtained in step (d) to an additional fractional distillative purification before submitting the cyclic-polydimethylsiloxane-containing composition to the equilibration reaction in step (a),
(a) submitting a cyclic-polydimethylsiloxane-containing composition comprising at least one cyclic polydimethylsiloxane to an equilibration reaction with at least one poly(methylhydrogen)siloxane in the presence of at least one equilibration catalyst to form a poly(methylhydrogen)-polydimethylsiloxane copolymer; and
(b) submitting the poly(methylhydrogen)-polydimethylsiloxane copolymer obtained in step (a) to a hydrosilylation reaction with at least one polyether comprising at least one carbon-carbon double bond reactive to Si—H bonds, preferably in the presence of at least one hydrosilylation catalyst, to obtain a polyether polydimethylsiloxane.
3. The process according to any one of aspects 1 or 2, wherein the cyclic-polydimethylsiloxane-containing composition comprises at most 0.25 mol % of M units, or preferably at most 0.15 mol % of M units, or more preferably at most 0.05 mol % M units, based on the total mols of M, D, T, and Q units of the cyclic-polydimethylsiloxane-containing composition.
4. The process according to any one of the preceding aspects, wherein the sum of T and Q units of the cyclic-polydimethylsiloxane-containing composition is at most 0.75 mol %, or preferably at most 0.5 mol %, or more preferably at most 0.25 mol %, based on the total mols of M, D, T, and Q units of the cyclic-polydimethylsiloxane-containing composition.
5. The process according to any one of the preceding aspects, wherein the sum of M, T, and Q units of the cyclic-polydimethylsiloxane-containing composition is at most 1.00 mol %, or preferably at most 0.65 mol %, or more preferably at most 0.3 mol %, based on the total mols of M, D, T, and Q units of the cyclic-polydimethylsiloxane-containing composition.
6. The process according to any one of the preceding aspects, wherein the at least one cyclic polydimethylsiloxane of the cyclic-polydimethylsiloxane-containing composition is not derived from methylchlorosilanes.
7. The process according to any one of the preceding aspects, wherein the at least one cyclic polydimethylsiloxane of the cyclic-polydimethylsiloxane-containing composition is not obtained from products of the Müller-Rochow process.
8. The process according to any one of the preceding aspects, wherein the at least one cyclic polydimethylsiloxane is at least one recycled cyclic polydimethylsiloxane.
9. The process according to any one of the preceding aspects, wherein the at least one cyclic polydimethylsiloxane is at least partially derived from at least one linear or branched polydimethylsiloxane or copolymer thereof in a recycling process.
10. The process according to any one of the preceding aspects, wherein the cyclic-polydimethylsiloxane-containing composition is substantially free of chlorine-containing compounds, or is most preferably completely free of chlorine-containing compounds and/or wherein the cyclic-polydimethylsiloxane-containing composition comprises less than 100 ppm chlorine-containing compounds, preferably less than 50 ppm chlorine-containing compounds, more preferably less than 25 ppm chlorine-containing compounds, and most preferably less than 10 ppm chlorine-containing compounds, based on the total weight of the cyclic-polydimethylsiloxane-containing composition.
11. The process according to any one of the preceding aspects, wherein the cyclic-polydimethylsiloxane-containing composition has a total content of the at least one cyclic polydimethylsiloxane of more than 90% by weight, preferably more than 95% by weight, or even more preferably by 98% by weight, based on the total weight of the cyclic-polydimethylsiloxane-containing composition.
12. The process according to any one of the preceding aspects, wherein the cyclic-polydimethylsiloxane-containing composition comprises at most 0.05% by weight, preferably at most 300 ppm, or 100 ppm, more preferably at most 40 ppm by weight, most preferably at most 10 ppm water as measured according to DIN 51777:2020-04, based on the total weight of the cyclic-polydimethylsiloxane-containing composition.
13. The process according to any one of the preceding aspects, wherein the at least one linear or branched polydimethylsiloxane or copolymer thereof is a linear polydimethylsiloxane homopolymer.
14. The process according to any one of the preceding aspects, wherein the cyclic-polydimethylsiloxane-containing composition comprises at most 0.5 mol %, preferably at most 0.2 mol %, more preferably at most 0.1 mol % vinyl-substituted silicon atoms as determined based on ²⁹Si-NMR spectroscopy, based on the total mols of silicon atoms in the cyclic-polydimethylsiloxane-containing composition.
15. The process according to any one of the preceding aspects, wherein the cyclic-polydimethylsiloxane-containing composition comprises at most 0.2 mol %, preferably at most 0.1 mol %, more preferably at most 0.05 mol % hydroxyl-substituted silicon atoms as determined based on ²⁹Si-NMR spectroscopy, based on the total mols of silicon atoms in the cyclic-polydimethylsiloxane-containing composition.
16. The process according to any one of the preceding aspects, wherein the cyclic-polydimethylsiloxane-containing composition has an octamethylcyclotetrasiloxane content of between 40% and 90% by weight, preferably between 45% and 80% by weight, more preferably between 50% and 80% by weight, based on the total weight of the cyclic-polydimethylsiloxane-containing composition.
17. The process according to any one of the preceding aspects, wherein the cyclic-polydimethylsiloxane-containing composition has a hexamethylcyclotrisiloxane content of between 0.1% and 6% by weight, preferably between 0.3% and 5% by weight, more preferably between 1% and 4% by weight, based on the total weight of the cyclic-polydimethylsiloxane-containing composition.
18. The process according to any one of the preceding aspects, wherein the at least one cyclic polydimethylsiloxane has a carbon footprint of less than 4 kg CO₂ equivalents/kg of the at least one cyclic polydimethylsiloxane or preferably of less than 2 kg CO₂ equivalents/kg of the at least one cyclic polydimethylsiloxane as determined according to DIN EN ISO standard 14067:2018.
19. The process according to any one of the preceding aspects, wherein the at least one linear or branched polydimethylsiloxane or copolymer thereof comprises at least 50% by weight, preferably at least 90% by weight, more preferably at least 99% by weight dimethylsiloxane units, based on the total weight of the at least one linear or branched polydimethylsiloxane or copolymer thereof.
20. The process according to any one of the preceding aspects, wherein the at least one linear or branched polydimethylsiloxane or copolymer thereof corresponds to or is derived from a waste polydimethylsiloxane polymer or copolymer material, a wide-spec polydimethylsiloxane polymer or copolymer material, a used polydimethylsiloxane polymer or copolymer material, an expired polydimethylsiloxane polymer or copolymer material, a surplus polydimethylsiloxane polymer or copolymer material, or any mixtures or combinations thereof.
21. The process according to any one of aspects 1 and 3 to 20, wherein the at least one linear or branched polydimethylsiloxane or copolymer thereof is contained in a polydimethylsiloxane-containing composition.
22. The process according to any one of aspects 2 and 21, wherein the polydimethylsiloxane-containing composition comprises at least 50% by weight, or preferably at least 70% by weight, or more preferably at least 90% percent by weight of the at least one linear or branched polydimethylsiloxane or copolymer thereof, based on the total weight of the polydimethylsiloxane-containing composition.
23. The process according to any one of aspects 2, 21 and 22, wherein the polydimethylsiloxane-containing composition has a silicon content of from 19% to 38% by weight, preferably from 26% to 38% by weight, more preferably from 34% to 38% weight, based on the total weight of the polydimethylsiloxane-containing composition.
24. The process according to any one of aspects 2 and 21 to 23, wherein the polydimethylsiloxane-containing composition comprises less than 50% by weight, preferably less than 25% by weight, more preferably less than 5% by weight fillers, based on the total weight of the polydimethylsiloxane-containing composition.
25. The process according to any one of the preceding aspects, wherein the at least one linear or branched polydimethylsiloxane or copolymer thereof has a ratio of M units to D units of at least 1:500, or preferably at least 1:750, or more preferably at least 1:1000.
26. The process according to any one of the preceding aspects, wherein the at least one linear or branched polydimethylsiloxane or copolymer thereof is a polydimethylsiloxane oil, a polydimethylsiloxane elastomer, a polydimethylsiloxane rubber, or a mixture thereof, whereby the polydimethylsiloxane oil preferably has a viscosity at 25° C. of at least 1000 mPa·s as measured according to DIN 53019-1:2008-09.
27. The process according to any one of the preceding aspects, wherein the at least one linear or branched polydimethylsiloxane or copolymer thereof is a polydimethylsiloxane oil and the polydimethylsiloxane oil preferably has a viscosity at 25° C. of at least 1000 mPa·s as measured according to DIN 53019-1:2008-09.
28. The process according to any one of the preceding aspects, wherein at least one further cyclic polydimethylsiloxane obtained from the hydrolysis of chlorosilanes is added to the cyclic-polydimethylsiloxane-containing composition before being submitted to the equilibration reaction.
29. The process according to any one of aspects 1 and 3 to 28, wherein the at least one cyclic polydimethylsiloxane is at least partially derived from at least one linear or branched polydimethylsiloxane or copolymer thereof by at least
   submitting a polydimethylsiloxane-containing composition comprising the at least one linear or branched polydimethylsiloxane or copolymer thereof to catalytic depolymerization in the presence of at least one depolymerization catalyst to form at least one cyclic polydimethylsiloxane in a depolymerization reaction mixture; and
   distilling the depolymerization reaction mixture to obtain the cyclic-polydimethylsiloxane-containing composition comprising the at least one cyclic polydimethylsiloxane;
wherein the cyclic-polydimethylsiloxane-containing composition is optionally submitted to an additional fractional distillative purification before being submitted to the equilibration reaction.
30. The process according to any one of aspects 2 and 29, wherein the catalytic depolymerization is carried out at a temperature of between 40° C. and 200° C. or preferably between 50° C. and 190° C., or more preferably between 80° C. and 180° C.
31. The process according to any one of aspects 2, 29, and 30, wherein the at least one depolymerization catalyst is selected from Bronsted acids or Bronsted bases, whereby the Bronsted acids are preferably selected from the group consisting of trifluoromethanesulfonic acid, sulfuric acid, hydrochloric acid, and combinations thereof; and the Bronsted bases are preferably selected from the group consisting of alkali metal hydroxides, tetraalkylammonium hydroxides, tetraalkylphosphonium hydroxides, phosphazenes, guanidines, and combinations thereof.
32. The process according any one of aspects 2 and 29 to 31, wherein the catalytic depolymerization is carried out in a reactor that is resistant to corrosion and temperatures of at least 250° C.
33. The process according any one of aspects 2 and 29 to 32, wherein distilling the depolymerization reaction mixture is at least partially carried out during the catalytic depolymerization.
34. The process according to any one of the preceding aspects, wherein the equilibration reaction is carried out in the presence of at least one chain length modifier, whereby the at least one chain length modifier is preferably selected from the group comprising hexamethyldisiloxane, 1,1,3,3-tetramethyldisiloxane, a HSiMe₂-endfunctional polydimethylsiloxane oil, and mixtures thereof.
35. The process according to any one of the preceding aspects, wherein the at least one equilibration catalyst is selected from acidic equilibration catalysts, whereby the acidic equilibration catalysts are preferably selected from the group consisting of strong protic acids such as sulfuric acid, trifluoromethanesulfonic acid, methanesulfonic acid, and perchloric acid, protic and Lewis acids such as HCl+FeCl₃ and HCl+SbCl₆, acid-activated minerals such as bleaching earths, and cation exchange resins such as sulfonic acid, macro-crosslinked cation exchange resins, and combinations thereof.
36. The process according to aspect 34, wherein the amount of the at least one chain length modifier is adjusted based on the content of M units in the cyclic-polydimethylsiloxane-containing composition.
37. The process according to any one of the preceding aspects, wherein the equilibration reaction is carried out at a temperature of between 10° C. and 110° C., or preferably between 25° C. and 100° C.
38. The process according to any one of the preceding aspects, wherein the poly(methylhydrogen)-polydimethylsiloxane copolymer has a density at 25° C. of from 0.95 to 0.98 g/mL, or preferably from 0.96 to 0.98 g/mL, or more preferably from 0.97 to 0.98 g/mL determined according to DIN 51757:2011-01.
39. The process according to any one of the preceding aspects, wherein the poly(methylhydrogen)-polydimethylsiloxane copolymer has a viscosity at 25° C. of from 2 to 2000 mPa·s, or preferably from 3 to 1000 mPa·s, or more preferably from 10 to 500 mPa·s determined according to DIN 53019-1:2008-09.
40. The process according to any one of the preceding aspects, wherein the poly(methylhydrogen)-polydimethylsiloxane copolymer has an SiH value of from 0.2 to 10 mol/kg, or preferably from 0.4 to 8 mol/kg, or more preferably from 0.6 to 6 mol/kg measured with gas volumetry.
41. The process according to any one of the preceding aspects, wherein the poly(methylhydrogen)-polydimethylsiloxane copolymer has
   (A) a density at 25° C. of from 0.94 to 0.99 g/mL, preferably from 0.95 to 0.98 g/mL, or more preferably from 0.96 to 0.98 g/mL determined according to DIN 51757:2011-01; a viscosity at 25° C. of from 50 to 70 mPa·s, preferably from 52 to 64 mPa·s, more preferably from 53 to 63 mPa·s determined according to DIN 53019-1:2008-09; and an SiH value of from 1.1 to 1.60 mol/kg, preferably from 1.0 to 1.50 mol/kg, more preferably from 1.2 to 1.45 mol/kg measured with gas volumetry; or
   (B) a density at 25° C. of from 0.95 to 1.00 g/mL, preferably from 0.96 to 0.99 g/mL, or more preferably from 0.965 to 0.972 g/mL determined according to DIN 51757:2011-01; a viscosity at 25° C. of from 60 to 85 mPa·s, preferably from 64 to 84 mPa·s, more preferably from 67 to 85 mPa·s determined according to DIN 53019-1:2008-09; and an SiH value of from 1.40 to 1.80 mol/kg, preferably from 1.50 to 1.70 mol/kg, more preferably from 1.57 to 1.67 mol/kg measured with gas volumetry.
42. The process according to any one of the preceding aspects, wherein the poly(methylhydrogen)-polydimethylsiloxane copolymer is separated from cyclic polydimethylsiloxanes and other volatiles by applying heat and vacuum to the equilibration reaction mixture obtained in step (a) before submitting the poly(methylhydrogen)-polydimethylsiloxane copolymer to the hydrosilylation reaction.
43. The process according to any one of the preceding aspects, wherein the hydrosilylation reaction is carried out at a temperature of between 20° C. and 140° C., or preferably between 40° C. and 130° C., or more preferably between 60° C. and 110° C.
44. The process according to any one of the preceding aspects, wherein the at least one hydrosilylation catalyst is a noble metal catalyst, preferably Pt(0) or rhodium.
45. The process according to any one of the preceding aspects, wherein the polyether polydimethylsiloxane has a viscosity at 25° C. of from 100 mPa·s to 12000 mPa·s or preferably from 200 to 8000 mPa·s as determined according to DIN 53019-1:2008-09.
46. The process according to any one of the preceding aspects, wherein the polyether polydimethylsiloxane has
(A) a density at 25° C. of from 1.030 to 1.060 g/mL, preferably from 1.032 to 1.057 g/mL, or more preferably from 1.035 to 1.055 g/mL determined according to DIN 51757:2011-01; and a viscosity at 25° C. of from 700 to 1300 mPa·s, preferably from 750 to 1250 mPa·s, more preferably from 800 to 1200 mPa·s determined according to DIN 53019-1:2008-09; or
(B) a density at 25° C. of from 1.010 to 1.050 g/mL, preferably from 1.015 to 1.045 g/mL, or more preferably from 1.020 to 1.040 g/mL determined according to DIN 51757:2011-01; and a viscosity at 25° C. of from 500 to 1000 mPa·s, preferably from 530 to 900 mPa·s, more preferably from 550 to 850 mPa·s determined according to DIN 53019-1:2008-09.
47. A composition for preparing a polymer foam comprising at least one monomer and one or more polyether polydimethylsiloxanes obtained according to the process of any one of aspects 1 to 46, whereby the polymer foam is preferably a polyurethane foam, a phenol resin foam, or a polyvinylchloride foam, more preferably a polyurethane foam.
48. A method for preparing a polymer foam comprising reacting one or more monomer species in the presence of one or more polyether polydimethylsiloxanes obtained according to the process of any one of aspects 1 to 46 to obtain a polymer foam.
49. An article comprising the polymer foam obtained according to the method according to aspect 48 or as the reaction product of the composition of aspect 47.
50. Use of a cyclic-polydimethylsiloxane-containing composition comprising at least one cyclic polydimethylsiloxane in an equilibration reaction for obtaining a poly(methylhydrogen)-polydimethylsiloxane copolymer in a process for producing a polyether polydimethylsiloxane, wherein the at least one cyclic polydimethylsiloxane is at least partially derived from at least one linear or branched polydimethylsiloxane or copolymer thereof.
51. The use according to aspect 50, wherein the cyclic-polydimethylsiloxane-containing composition is as defined in any one of aspects 3 to 5, 10 to 12 and 14 to 17.
52. The use according to aspect 50 or 51, wherein the cyclic polydimethylsiloxane is as defined in any one of aspects 2, 6 to 9, 18, and 29 to 33.
53. The use according to any one of aspects 50 to 52, wherein the poly(methylhydrogen)-polydimethylsiloxane copolymer is as defined in any one of aspects 38 to 42.
54. The use according to any one of aspects 50 to 53, wherein the at least one linear or branched polydimethylsiloxane or copolymer thereof is as defined in any one of aspects 13 and 19 to 27.
55. The use according to any one of aspects 50 to 54, wherein the polyether polydimethylsiloxane is as defined in any one of aspects 45 or 46.
56. The use according to any one of aspects 50 to 55, wherein the equilibration reaction is carried out as defined in any one of aspects 34 to 37.
57. The use according to any one of aspects 50 to 56, further comprising submitting the poly(methylhydrogen)-polydimethylsiloxane copolymer obtained in the equilibration reaction to a hydrosilylation reaction with at least one polyether comprising at least one carbon-carbon double bond reactive to Si—H bonds, preferably in the presence of at least one hydrosilylation catalyst, to obtain the polyether polydimethylsiloxane.
58. The use according to aspects 57, wherein the hydrosilylation reaction is carried out as defined in any one of aspects 43 and 44.
59. Use of at least one polyether polydimethylsiloxane obtained according to the process of any one of aspects 1 to 46 as an additive in a method of producing a polymer foam or a composition for preparing a polymer foam, whereby the polymer foam is preferably a polyurethane foam, a phenol resin foam, or a polyvinylchloride foam, more preferably a polyurethane foam.
60. Use of a recycled cyclic polydimethylsiloxane for producing a polyether polydimethylsiloxane, wherein the cyclic polydimethylsiloxane is derived from a linear or branched polydimethylsiloxane or copolymer thereof.
61. The use of aspect 60, wherein the recycled cyclic polydimethylsiloxane has a carbon footprint of less than 4 kg CO₂ equivalents/kg of the recycled cyclic polydimethylsiloxane or preferably of less than 2 kg CO₂ equivalents/kg of the recycled cyclic polydimethylsiloxane as determined according to DIN EN ISO standard 14067:2018.

### EXAMPLES

All amounts referred to throughout the examples are parts by weight, unless otherwise noted.

The abbreviation “comp.” mentioned in the examples stands for comparative and means a comparative composition or comparative example. The abbreviation “inv.” mentioned in the examples stands for inventive and means an inventive composition or inventive example.

### Example 1: Composition Derived from Müller-Rochow Process

Table 1 discloses two cyclic-polydimethylsiloxane-containing compositions, wherein one composition comprises cyclic polydimethylsiloxanes derived from the Müller-Rochow process (MR process) and the other composition according to the invention comprises cyclic polydimethylsiloxanes derived from recycling of PDMS. As can be seen from Table 1, the MR-process-based composition comprises chlorides in an amount of s 5 ppm, whereas the composition derived from PDMS does not comprise chlorides but small amounts of Si-vinyls, M-units and T-units. The predominant cyclic polydimethylsiloxane in the composition derived from the MR-process is octamethylcyclotetrasiloxane (D4).

TABLE 1
Comparison of cyclic-polydimethylsiloxane-
containing compositions

| | | | Composition derived from | |
|---|---|---|---|---|
| | Composition: | | PDMS (recycled cyclic | |
| | MR-process | | PDMS) | |
| Sum D3 to D8¹ | ≥99.0 | wt.-% | ≥99.0 | wt.-% |
| Water content² | ≤0.025 | wt.-% | ≤0.025 | wt.-% |

| Acid content³ | ≤2.0 mg HCl/kg | | ≤2.0 mg HCl/kg |
|---|---|---|---|
| Total chloride⁴ | ≤5 | ppm | Not detectable |

| | | | |
|---|---|---|---|
| Si-Vinyls⁵ | Not detectable | ≤0.5 | wt.-% |
| M-units (Me₃SiO_{1/2})⁶ | Not detectable | ≤0.2 | wt.-% |
| T-units (MeSiO_{3/2})⁶ | Not detectable | ≤0.1 | wt.-% |

¹The sum of D3 to D8 was measured by gas chromatography (GC) according to the following method: The substances are separated according to the boiling point and detected by means of a thermal conductivity detector (TCD). An aliquot of the sample to be examined is analyzed by GC without further dilution. This is carried out in a gas chromatograph equipped with a split/splitless injector, a capillary column and a thermal conductivity detector under the following conditions: Injector: 290° C., split 40 mL; Injection volume: 1 μL; Column: 5 m *0.32 mm HP5 1 μm; Carrier gas: Hydrogen, const. flow 2 mL/min; Temperature program: 1 minute at 80° C., then 80° C.-300° C. at 30° C./min, then conditioning for 10 minutes at 300° C.; Detector: TCD at 320° C.; Make Up Gas flow: 8 mL/min; Reference gas flow: 22 mL/min. The cyclic siloxanes are separated according to their boiling point. The mass fraction of the individual substances is determined as a percentage of the peak areas determined for the respective substance compared to the total area of all detected substances (area-% method).
²The water content is the amount of water calculated by the Water determination by Karl Fischer, following DIN 51777: 2020-04.
³The acid content was measured according to DIN EN ISO 2114 - 2002-06.
⁴The content of cloride was determined by potentiometric titration with silver nitrate solution following DGF H-III 9, Deutsche Einheitsmethoden zur Untersuchung von Fetten, Fettprodukten, Tensiden und verwandten Stoffen, 2021, 2. Auflage.
⁵The Si-vinyls was measured by ²⁹Si-NMR spectroscopy. The molar fraction of Si-vinyls is determined by setting the sum of the signal intensities of the signals from −3 to −5 ppm in relation to the sum of the signal intensities of all signals without the standard. Suitable parameters for recording the ²⁹Si-NMR can be found in the following literature: M. Cypryk, K. Kaźmierski, W. Fortuniak, and J. Chojnowski, Macromolecules 2000, 33, 5, 1536-1545.
⁶The content of M-units and T-units were measured by ²⁹Si-NMR. The molar fraction of M-units can be determined using ²⁹Si-NMR. M-units result in signals in the range of 6-9 ppm, D units of −16 to −24 ppm T units of −40 to −80 ppm and Q units of 95 to 140 ppm. The proportion of the M-units is determined by setting the sum of the signal intensities of the signals from 6-9 ppm in relation to the sum of the signal intensities of all signals of the M, D, T and Q units (without the standard). Suitable parameters for recording the ²⁹Si-NMR can be found in the following literature: M. Cypryk, K. Kaźmierski, W. Fortuniak, and J. Chojnowski, Macromolecules 2000, 33, 5, 1536-1545.

### Example 2: Cyclic-polydimethylsiloxane-Containing Compositions

Table 2 reveals the cyclic-polydimethylsiloxane-containing compositions used for the manufacturing of polyether polydimethylsiloxanes. These compositions comprise cyclic polydimethylsiloxanes which are derived from at least one linear or branched polydimethylsiloxane or copolymer thereof. More particularly, these compositions were obtained by submitting a polydimethylsiloxane-containing composition comprising at least one linear or branched polydimethylsiloxane or copolymer thereof to catalytic depolymerization followed by distillative purification. The inventive Compositions A, G, H, I and J comprises over 0.5 wt.-% of hexamethylcyclotrisiloxane (D3). Compositions A, G, and H comprises an increased water content.

The “sum” indicated in Table 2 relates to the sum of D3 to D6.

TABLE 2
Cyclic-polydimethylsiloxane-containing compositions

| Cyclic | | | | | | |
|---|---|---|---|---|---|---|
| organosiloxane- | | D3⁷ | D4⁷ | D5⁷ | D6⁷ | Sum |
| containing | Water² | (wt.- | (wt.- | (wt.- | (wt.- | (wt.- |
| composition | (ppm) | %) | %) | %) | %) | %) |
| Inventive A | 10 | 4.70 | 69.40 | 20.20 | 2.90 | 92.50 |
| Inventive B | 0 | 0.47 | 96.60 | 1.70 | 0.01 | 97.71 |
| Inventive C | 0 | N/A | 78.30 | 11.80 | 0.74 | 90.84 |
| Inventive D | 0 | N/A | 89.47 | 1.79 | 0.00 | 91.26 |
| Inventive E | 0 | N/A | 96.95 | 0.06 | 0.00 | 99.88 |
| Inventive F | 0 | 0.03 | 99.91 | 0.06 | 0.00 | 100.00 |
| Inventive G | 3.89 | 4.38 | 74.27 | 19.16 | 1.32 | 99.12 |
| Inventive H | 42.80 | 3.68 | 67.17 | 22.96 | 3.79 | 97.59 |
| Inventive I | 0.01 | 4.94 | 67.73 | 22.96 | 3.44 | 99.07 |
| Inventive J | 0.01 | 4.88 | 67.08 | 23.48 | 3.60 | 99.04 |

⁷The content of D3, D4, D5 and D6 was measured by gas chromatography (GC) according to the method described under footnote 1 in respect of Table 1 hereinabove.

### Example 3: Equilibration Reaction

In a 500 mL four-neck flask equipped with dropping funnel, stirrer, thermometer, gas inlet and reflux condenser, a mixture consisting of 218.3 g of the respective cyclic organosiloxane-containing composition of Example 2, 21.9 g of poly(methyl)hydrogen siloxane (CAS: 63148-57-2, SiH-content: 15.75 mol/kg) and 9.8 g of hexamethyldisiloxane (CAS: 107-46-0) was blended and 0.25 g trifluoromethanesulfonic acid (CAS: 1493-13-6; purity>99%) was added. The mixture was stirred for 6 hours or 4 hours at 35° C. with constant stirring. Thereafter, 2.5 g NaHCO₃ was added, and the mixture was stirred for another 2 hours. The mixture was filtered and the filtrate was then freed from volatile components on a rotary evaporator at 130° C. and a reduced pressure of <1 mbar. The product was the distillation bottom (i.e., the poly(methylhydrogen)-polydimethylsiloxane copolymer).

In Table 3 the equilibration reaction conditions using the respective cyclic organosiloxane-containing composition as mentioned in Table 2 and the produced poly(methylhydrogen)-polydimethylsiloxane copolymers are shown. The viscosity of Example H1 was out of the target specification so that the experiment was repeated (Example H2). In Example H2, a higher amount of catalyst was used.

TABLE 3
Equilibration reaction

| Equilibration reaction | | | | | |
|---|---|---|---|---|---|
| Comp. MR¹² | Inv. A | Inv. B | Inv. D | Inv. E | Inv. F |
| Cyclic-organosiloxane-containing compositions | | | | | |
| MR | Inv. A | Inv. B | Inv. D | Inv. E | Inv. F |

Equilibration reaction conditions

| | | | | | | |
|---|---|---|---|---|---|---|
| Equilibration Time (h) | 6 | 6 | 6 | 6 | 6 | 6 |
| SiH value (mol/kg)⁸ | 1.39 | 1.40 | 1.40 | 1.52 | 1.37 | 1.38 |
| Density at 25 °C (g/mL)⁹ | 0.962 | 0.960 | 0.960 | 0.960 | 0.966 | 0.967 |
| Viscosity 25 °C (mPa · s)¹⁰ | 46 | 36 | 38 | 36 | 45 | 45 |

Poly(methylhydrogen)-polydimethylsiloxane copolymer

| | | | | | | |
|---|---|---|---|---|---|---|
| SiH value (mol/kg)⁸ | 1.36 | 1.29 | 1.34 | 1.37 | 1.3 | 1.35 |
| Density at 25 °C (g/mL)⁹ | 0.963 | 0.963 | 0.964 | 0.964 | 0.969 | 0.969 |
| Viscosity 25 °C (mPa · s)¹⁰ | 57 | 51.3 | 56.8 | 72.0 | 60.3 | 57.7 |
| D4 residue (weight-%)⁷ | 0.01 | 0.23 | 0.05 | 0 | 0 | 0 |
| D5 residue (weight-%)⁷ | 0.01 | 0.99 | 0.03 | 0 | 0.04 | 0 |
| D6 residue (weight-%)⁷ | 0.05 | 0.50 | 0.00 | 0.07 | 0.1 | 0.08 |
| Sum of D4, D5, and D6 | 0.07 | 1.72 | 0.08 | 0.07 | 0.14 | 0.08 |
| (weight-%)¹¹ | | | | | | |

| Equilibration reaction | | | | |
|---|---|---|---|---|
| Inv. G | Inv. H1 | Inv. H2¹³ | Inv. I | Inv. J |
| Cyclic-organosiloxane-containing compositions | | | | |
| Inv G | Inv. H | Inv. H | Inv. I | Inv. J |

Equilibration reaction mixture

| | | | | | |
|---|---|---|---|---|---|
| Equilibration Time (h) | 4 | 4 | 4 | 4 | 6 |
| SiH value (mol/kg)⁸ | 1.38 | 1.38 | 1.38 | 1.39 | |
| Density at 25 °C (g/mL)⁹ | 0.961 | 0.961 | 0.967 | 0.967 | |
| Viscosity 25 °C (mPa · s)¹⁰ | 42 | 12 | 43 | 43 | |

Poly(methylhydrogen)-polydimethylsiloxane copolymer

| | | | | | |
|---|---|---|---|---|---|
| SiH value (mol/kg)⁸ | 1.35 | N/A | 1.36 | 1.33 | 1.43 |
| Density at 25 °C (g/mL)⁹ | 0.969 | N/A | 0.970 | 0.964 | 0.963 |
| Viscosity 25 °C (mPa · s)¹⁰ | 55.4 | N/A | 58.2 | 57.893 | 53 |
| D4 residue (weight-%)⁷ | 0 | N/A | 0 | 0 | 0 |
| D5 residue (weight-%)⁷ | 0 | N/A | 0 | 0 | 0 |
| D6 residue (weight-%)⁷ | 0.08 | N/A | 0.08 | 0.1 | 0.03 |
| Sum of D4, D5, and D6 | 0.08 | N/A | 0.08 | 0.1 | 0.03 |
| (weight-%)¹¹ | | | | | |

⁸The SiH value was measured according to the following procedure: 15 mL of sodium butylate solution (5 wt-% in butanol) were added to approx. 3 g hydrogensiloxane sample. The volume of hydrogen formed is determined with the help of a burette. With the help of the ideal gas law, the content of SiH groups is determined and calculated in the unit mol/kg.
⁹The density was measured according to DIN 51757: 2011-1.
¹⁰The viscosity was measured according to DIN 53019-1: 2008-09, DIN 53019-2: 2001-02, DIN 53019-3: 2008-09 and DIN 53019-4: 2016-10.
¹¹The sum of D3 to D6 was measured by gas chromatography (GC) according to the method described under footnote 1 in respect of Table 1 hereinabove.
¹²Obtained from the MR-process as comparative example.
¹³Inventive H2: An additional amount of the catalyst was added after 2 h of the equilibration reaction.

Comparative composition MR is a composition derived from products of the Müller-Rochow Process. The equilibration reaction time of 4 hours respectively 6 hours was sufficient to achieve equilibration. However, the composition of Example H2 reveals that a second charge of catalyst was beneficial for the equilibration reaction. It is believed that the water content had a negative influence on the equilibration reaction.

### Example 4: Hydrosilylation Reaction

In a 250 mL four-neck flask equipped with a dropping funnel, a stirrer, a thermometer, a gas inlet, and a reflux condenser, a mixture consisting of 51.4 g of a polyether having the average formula: CH₂═CHCH₂O—(H₂CH₂O)₁₀(CH₂CH(CH₃)O)₂OH and 43.5 g of the respective poly(methylhydrogen)-polydimethylsiloxane copolymer of Example 3 was blended. The mixture was stirred and heated to 90° C. 2.6 ppm Platinum in form of a Pt(0)-1,3-divinyl-1,1,3,3-tetramethyldisiloxane complex solution (CAS: 68478-92-2) was added. An exothermic reaction took place. By cooling, the reaction mixture was kept at a temperature below 100° C. The reaction mixture was then stirred for 2 h at 90° C. A clear, homogeneous product was obtained. Finally, 5.0 g 1,2-propylenglycol and 0.05 g triisopropanolamine amine were added. In table 4 the results of the hydrosilylation reaction are shown in table 4.

TABLE 4
Hydrosilylation reaction

| Hydro silylation | Inv. A | Inv. B | Inv. D1 | Inv. D2 | Inv. E |
|---|---|---|---|---|---|
| Equilibration | Inv. A | Inv. B | Inv. D | Inv. D | Inv. E |
| reaction | | | | | |
| Catalyst (ppm) | 2.6 | 2.6 | 2.6 | 2.0 | 2.0 |
| Temperature (° C.) | 90 | 90 | 90 | 90 | 90 |
| Clear Times (min) | 6 | 6 | 7 | 11 | 8 |
| Conversion at 2 h | 99.50 | 90.90 | 100.00 | 94.90 | 100.00 |
| (%) | | | | | |
| Conversion at 3 h | N/A | 93.5 | N/A | N/A | N/A |
| (%) | | | | | |
| Conversion at 4 h | N/A | 99.2 | N/A | 99.2 | N/A |
| (%) | | | | | |
| Density at 25° C. | 1.031 | 1.032 | 1.032 | N/A | 1.033 |
| (g/mL)⁹ | | | | | |
| pH-value 4% | 7.0 | 7.3 | 7 | N/A | 7.2 |
| Viscosity at 25° C. | 594 | 707 | 1558 | N/A | 685 |
| (mPa · s)¹⁰ | | | | | |
| Hydro silylation | Inv. F | Inv. G | Inv. H2 | Inv. I | Inv. J |
| Equilibration | Inv. F | Inv. G | Inv. H2 | Inv. I | Inv. J |
| reaction | | | | | |
| Catalyst (ppm) | 2.0 | 2.0 | 2.0 | 2.0 | 2.0 |
| Temperature (° C.) | 90 | 90 | 90 | 90 | 90 |
| Clear Times (min) | N/A | 8 | 8 | 9 | N/A |
| Conversion at 2 h | 100 | 100 | 100 | 100 | 100 |
| (%) | | | | | |
| Conversion at 3 h | N/A | N/A | N/A | N/A | N/A |
| (%) | | | | | |
| Conversion at 4 h | N/A | N/A | N/A | N/A | N/A |
| (%) | | | | | |
| Density at 25° C. | 1.033 | 1.034 | 1.035 | 1.039 | a |
| (g/mL)⁹ | | | | | |
| pH-value 4% | 7.3 | 7.6 | 7.6 | 7.6 | |
| Viscosity at 25° C. | 716 | 809 | 795 | 749 | |
| (mPa · s)¹⁰ | | | | | |

### Example 5: Preparation of a Rigid Polyurethane Foam

A Bosch Lance Mold was cleaned and sprayed with a mold release agent. A water bath for the mold was installed having a temperature of 50° C. 195.50 g of the isocyanate was added to an 8 oz. polycoated paper cup. A second composition was prepared and added to a 44 oz. polycoated paper cup. The second composition comprises 2.6 g water, 1.5 g DMCHA, 1.5 g of the respective polyether polydimethylsiloxane of Example 4, and 13.0 g of cyclopentane (blowing agent). The second composition was mixed for 30 seconds using a stir blade at 1000 rpm. The first composition comprising the isocyanate was then transferred from the 8 oz. cup to the 44 oz. cup comprising the mixed second composition and mixed for 7 seconds using a stir blade at 2500 rpm. This composition is then poured into said Bosch Lance Mold at the designated pour point for 5 seconds to evaluate flowability (pour point is marked by tape on the side of the mold). After 10 min of curing, the foam is demolded. The specific amounts of the components including the polyether polydimethylsiloxanes as well as the properties of the obtained foams are indicated in Table 5 for each example.

TABLE 5
Rigid Foam Testing

| Foam | | | | | | |
|---|---|---|---|---|---|---|
| Comp. MR | Inv. A | Inv. B | Inv. D | Inv. D2 | Inv. E | Inv. F |
| polyether polydimethylsiloxane (g) | | | | | | |
| Comp. MR | Inv. A | Inv. B | Inv. D | Inv. D2 | Inv. E | Inv. F |
| 1.5 | 1.5 | 1.5 | 1.5 | 1.5 | 1.5 | 1.5 |

Composition for preparing the foam

| | | | | | | | |
|---|---|---|---|---|---|---|---|
| DMCHA (g)¹⁵ | 1.5 | 1.5 | 1.5 | 1.5 | 1.5 | 1.5 | 1.5 |
| Polyether polyol (g)¹⁶ | 100.0 | 100.0 | 100.0 | 100.0 | 100.0 | 100.0 | 100.0 |
| Isocyanate (g)¹⁷ | 198.5 | 198.5 | 198.5 | 198.5 | 198.5 | 198.5 | 198.5 |
| Water (g) | 2.6 | 2.6 | 2.6 | 2.6 | 2.6 | 2.6 | 2.6 |
| Cyclopentane (g) | 13.0 | 13.0 | 13.0 | 13.0 | 13.0 | 13.0 | 13.0 |

Properties of produced rigid foam

| | | | | | | |
|---|---|---|---|---|---|---|
| Flowablilty | −1.6 | 0.6 | −2.1 | −2.3 | −2.1 | 1.4 |
| Cell structure | Fine | Fine | Fine | Fine | Fine | Fine |
| Pass/Fail | Pass | Pass | Pass | Pass | Pass | Pass |

| | Foam | | |
|---|---|---|---|
| | Inv. G | Inv. H2 | Inv. I |
| | polyether polydimethylsiloxane (g) | | |
| | Inv. G | Inv. H2 | Inv. I |
| | 1.5 | 1.5 | 1.5 |
| DMCHA (g)¹⁵ | 1.5 | 1.5 | 1.5 |
| Polyether polyol (g)¹⁶ | 100.0 | 100.0 | 100.0 |
| Isocyanate (g)¹⁷ | 198.5 | 198.5 | 198.5 |
| Water (g) | 2.6 | 2.6 | 2.6 |
| Cyclopentane (g) | 13.0 | 13.0 | 13.0 |
| Flowablilty | 0.8 | −0.2 | 0.6 |
| Cell structure | Fine | Fine | Fine |
| Pass/Fail | Pass | Pass | Pass |

¹⁵N,N-Dimethylcyclohexylamine (DMCHA)
¹⁶Polyether polyol: Daltolac R-471, Huntsman International LLC
¹⁷Mondur MR, an aromatic polymeric isocyanate based on diphenylmethane-diisocyanate (MDI), Covestro AG, Leverkusen, Germany

1. A process for producing polyether polydimethylsiloxanes, comprising:
(a) submitting a cyclic-polydimethylsiloxane-containing composition, comprising at least one cyclic polydimethylsiloxane to an equilibration reaction with at least one poly(methylhydrogen)siloxane in the presence of at least one equilibration catalyst to form a poly(methylhydrogen)-polydimethylsiloxane copolymer; and
(b) submitting the poly(methylhydrogen)-polydimethylsiloxane copolymer obtained in (a) to a hydrosilylation reaction with at least one polyether, comprising at least one carbon-carbon double bond reactive to Si—H bonds to obtain a polyether polydimethylsiloxane;
wherein the at least one cyclic polydimethylsiloxane is at least partially derived from at least one linear or branched polydimethylsiloxane or copolymer thereof,
wherein the cyclic-polydimethylsiloxane-containing composition comprises at most 300 ppm water as measured according to DIN 51777:2020-04, based on the total weight of the cyclic-polydimethylsiloxane-containing composition, and
wherein the at least one linear or branched polydimethylsiloxane or copolymer thereof is contained in a poly dimethylsiloxane-containing composition and wherein the polydimethylsiloxane-containing composition
comprises at least 500% by weight of the at least one linear or branched polydimethylsiloxane or copolymer thereof, based on the total weight of the polydimethylsiloxane-containing composition; and/or
has a silicon content of from 19% to 38% by weight, based on the total weight of the polydimethylsiloxane-containing composition; and/or
comprises less than 50% by weight based on the total weight of the polydimethylsiloxane-containing composition.

2. The process according to claim 1, wherein the cyclic-polydimethylsiloxane-containing composition comprises at most 0.25 mol % of M units, based on the total mols of M, D, T, and Q units of the cyclic-polydimethylsiloxane-containing composition; and/or
wherein the sum of T and Q units of the cyclic-polydimethylsiloxane-containing composition is at most 0.75 mol %, based on the total mols of M, D, T, and Q units of the cyclic-polydimethylsiloxane-containing composition; and/or
wherein the sum of M, T, and Q units of the cyclic-polydimethylsiloxane-containing composition is at most 1.00 mol %, based on the total mols of M, D, T, and Q units of the cyclic-polydimethylsiloxane-containing composition.

3. The process according to claim 1, wherein the cyclic-polydimethylsiloxane-containing composition comprises
at most 0.05% by weight water as measured according to DIN 51777:2020-04, based on the total weight of the cyclic-polydimethylsiloxane-containing composition; and/or
at most 0.25 mol % of M units as determined based on ²⁹Si-NMR spectroscopy, based on the total mols of M, D, T, and Q units in the cyclic-polydimethylsiloxane-containing composition; and/or
at most 0.5 mol % vinyl-substituted silicon atoms as determined based on ²⁹Si-NMR spectroscopy, based on the total mols of silicon atoms in the cyclic-polydimethylsiloxane-containing composition; and/or
at most 0.2 mol % hydroxyl-substituted silicon atoms as determined based on ²⁹Si-NMR spectroscopy, based on the total mols of silicon atoms in the cyclic-polydimethylsiloxane-containing composition.

4. The process according to claim 1, wherein the at least one-cyclic polydimethylsiloxane is at least one recycled cyclic polydimethylsiloxane.

5. The process according to claim 1, wherein the at least one linear or branched poly dimethylsiloxane or copolymer thereof corresponds to or is derived from a waste polydimethylsiloxane polymer or copolymer material, a wide-spec-polydimethylsiloxane polymer or copolymer material, a used polydimethylsiloxane polymer or copolymer material, an expired-polydimethylsiloxane polymer or copolymer material, a surplus-polydimethylsiloxane polymer or copolymer material, and any mixtures or combinations thereof.

6. The process according to claim 1, wherein the at least one linear or branched poly dimethylsiloxane or copolymer thereof is selected from the group consisting of a polydimethylsiloxane oil, a polydimethylsiloxane elastomer, a polydimethylsiloxane rubber, and a mixture thereof.

7. The process according to claim 1, wherein the at least one-cyclic polydimethylsiloxane is at least partially derived from the at least one linear or branched polydimethylsiloxane or copolymer thereof by
submitting a poly dimethylsiloxane-containing composition, comprising the at least one linear or branched polydimethylsiloxane or copolymer thereof to catalytic depolymerization in the presence of at least one-depolymerization catalyst to form the at least one cyclic polydimethylsiloxane in a depolymerization reaction mixture; and
distilling the depolymerization reaction mixture to obtain the cyclic-polydimethylsiloxane-containing composition, comprising the at least one-cyclic polydimethylsiloxane;
wherein the cyclic-polydimethylsiloxane-containing composition is optionally submitted to an additional fractional distillative purification before being submitted to the equilibration reaction.

8. The process according to claim 1, wherein the poly(methylhydrogen)-polydimethylsiloxane copolymer has
a density at 25° C. of from 0.95 to 0.98 g/mL determined according to DIN 51757:2011-01;
a viscosity at 25° C. of from 2 to 2000 mPa·s determined according to DIN 53019-1:2008-09; and/or
an SiH value of from 0.2 to 10 mol/kg measured with gas volumetry.

9. A composition for preparing a polymer foam, comprising:
at least one monomer, and
one or more polyether polydimethylsiloxanes obtained according to the process of claim 1, wherein the polymer foam is at least one selected from the group consisting of a polyurethane foam, a phenol resin foam, and a polyvinylchloride foam.

10. A method for preparing a polymer foam, comprising:
reacting one or more monomers in the presence of a one or more polyether polydimethylsiloxanes obtained according to the process of claim 1 to obtain the polymer foam.

11. An article, comprising;
the polymer foam obtained according to the method according to claim 10.

12. A method for producing a polyether polydimethylsiloxane, comprising equilibrating and hydrosilylating a recycled cyclic polydimethylsiloxane;
wherein the recycled cyclic polydimethylsiloxane is derived from a linear or branched polydimethylsiloxane or copolymer thereof,
wherein the cyclic-polydimethylsiloxane-containing composition comprises at most 300 ppm water as measured according to DIN 51777:2020-04, based on the total weight of the cyclic-polydimethylsiloxane-containing composition, and
wherein the at least one linear or branched polydimethylsiloxane or copolymer thereof is contained in a poly dimethylsiloxane-containing composition and wherein the polydimethylsiloxane-containing composition;
comprises at least 50% by weight of the at least one linear or branched polydimethylsiloxane or copolymer thereof, based on the total weight of the polydimethylsiloxane-containing composition; and/or
has a silicon content of from 19% to 38% by weight based on the total weight of the polydimethylsiloxane-containing composition; and/or
comprises less than 50% by weight fillers based on the total weight of the polydimethylsiloxane-containing composition.

13. The method of claim 12, wherein the recycled cyclic polydimethylsiloxane has a carbon footprint of less than 4 kg CO₂ equivalents/kg of the recycled cyclic polydimethylsiloxane as determined according to DIN EN ISO standard 14067:2018.

14. A method for producing a polymer foam, comprising:
adding at least one polyether polydimethylsiloxane obtained according to the process of claim 1 to a polymer foam.
